(19) United States
(12) Patent Application Publication
(10) Pub. No.: US 2003/0205404 A1
(43) Pub. Date: Nov. 6, 2003

(54) Composite sheet and process for producing the same

(75) Inventors: Takeo Hara, Tokyo (JP); Shin-ichiro Iwanaga, Tokyo (JP); Hozumi Sato, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JSR CORPORATION, Chuo-ku (JP)

(21) Appl. No.: 09/827,927

(22) Filed: Apr. 9, 2001

(30) Foreign Application Priority Data
Apr. 10, 2000 (JP) 2000-107845
Jun. 9, 2000 (JP) 2000-173570
Sep. 19, 2000 (JP) 2000-283654
Oct. 12, 2000 (JP) 2000--312195
Oct. 30, 2000 (JP) 2000-331256

(51) Int. Cl. H01B 5/08; C08F 2/46; C08J 3/28; B32B 5/12

(52) U.S. Cl. 174/128.2; 522/1; 428/114

(57) ABSTRACT

The invention is a composite sheet used to bond semiconductor elements and circuit substrates together, containing a resin with magnetic and conductive particles. The invention includes processes for making the sheet and for using the sheet. The sheet includes a binder which contains photocuring and thermosetting components, and a fibrous filler which is both conductive and magnetic. A semicured conductive sheet can be obtained by light irradiation of the sheet. Thermocompression can be used for producing a semiconductor package. Reductions in conductive part pitch are achieved by adhering a noble metal onto the surface of the sheet. Thermal conductivity can be improved by inclusion of a filler having high thermal conductivity. Projections of binder containing magnetic fibrous fillers allows stable electrical conduction. Dispersion of fine particles in the binder inhibits deterioration of the sheets insulating abilities.

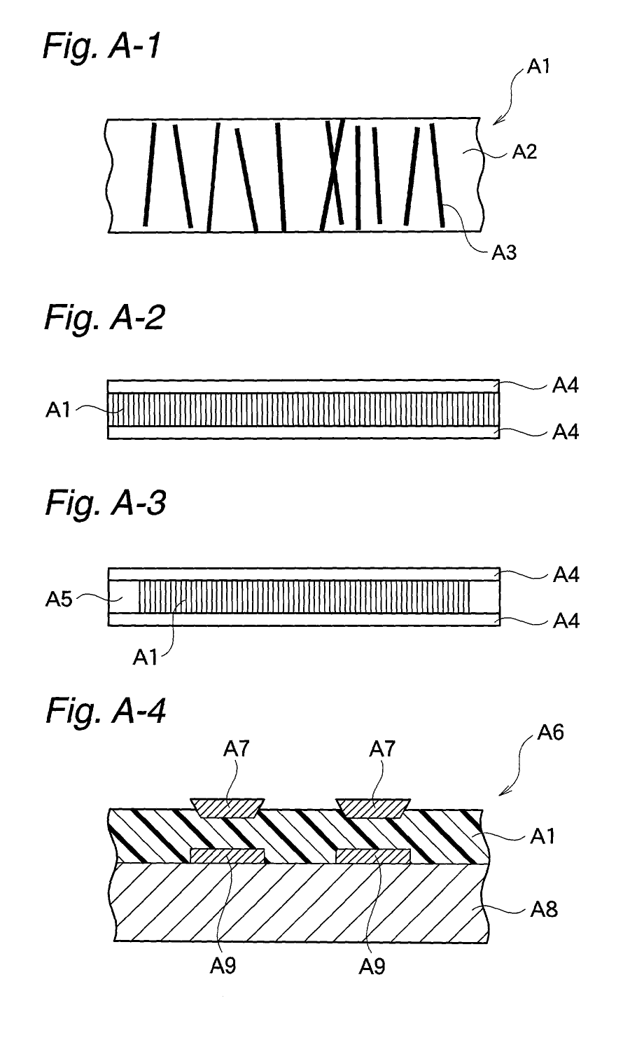

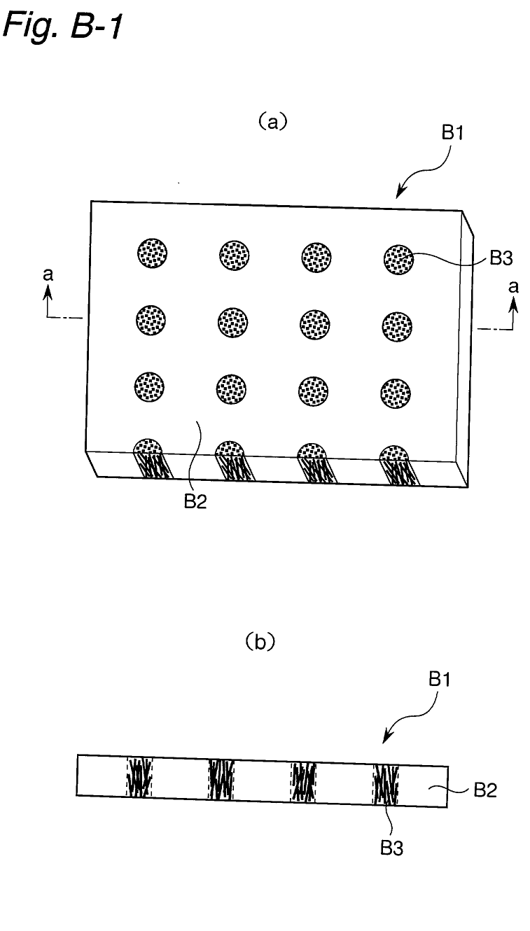

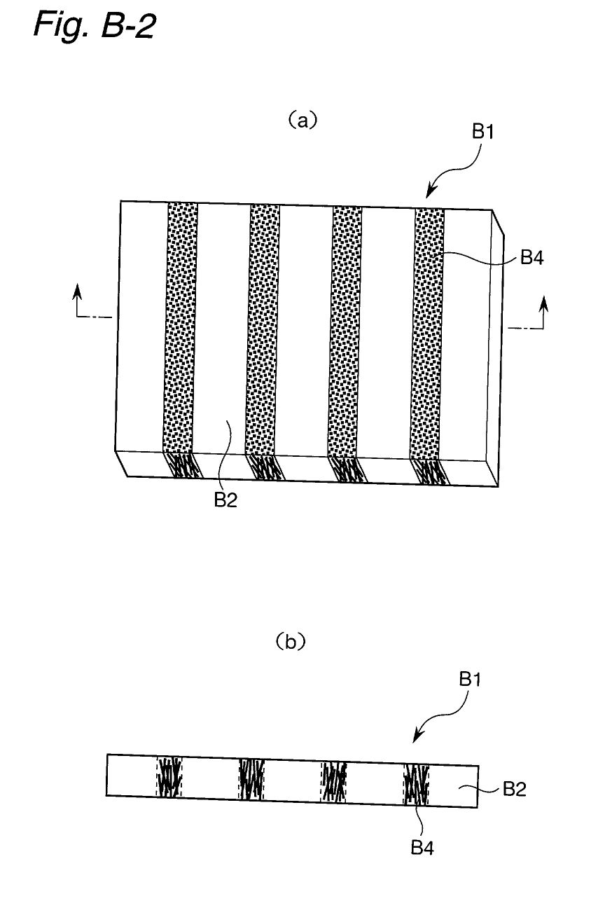

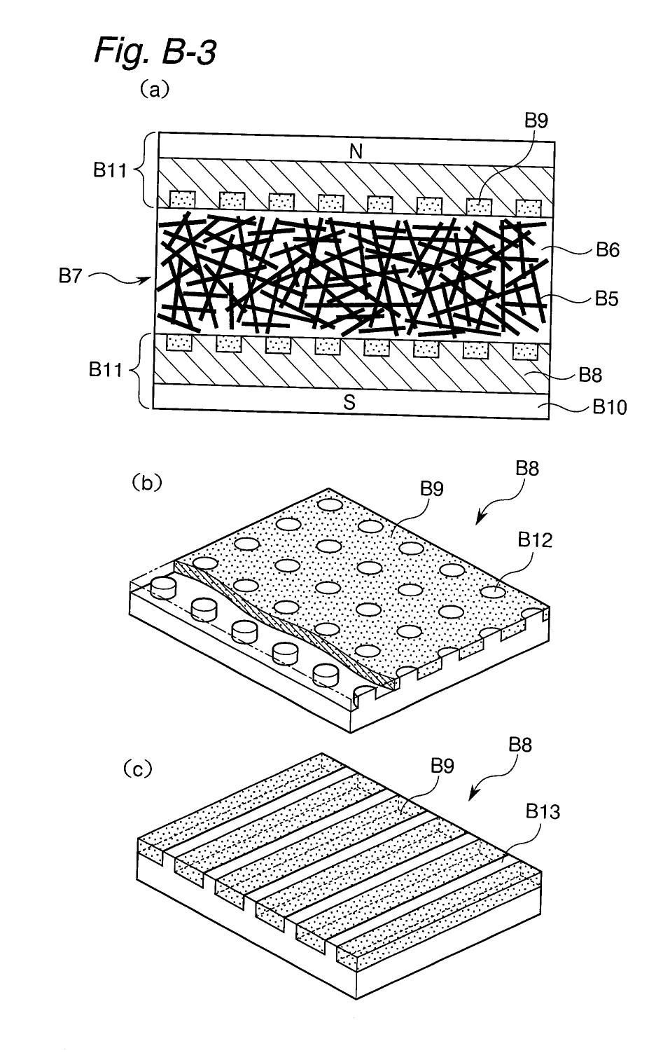

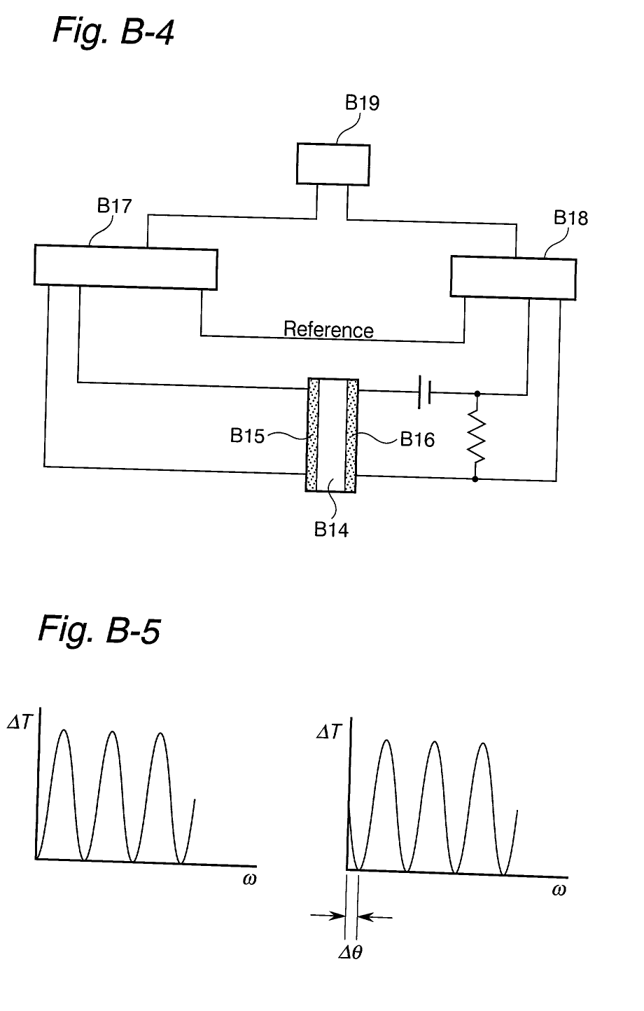

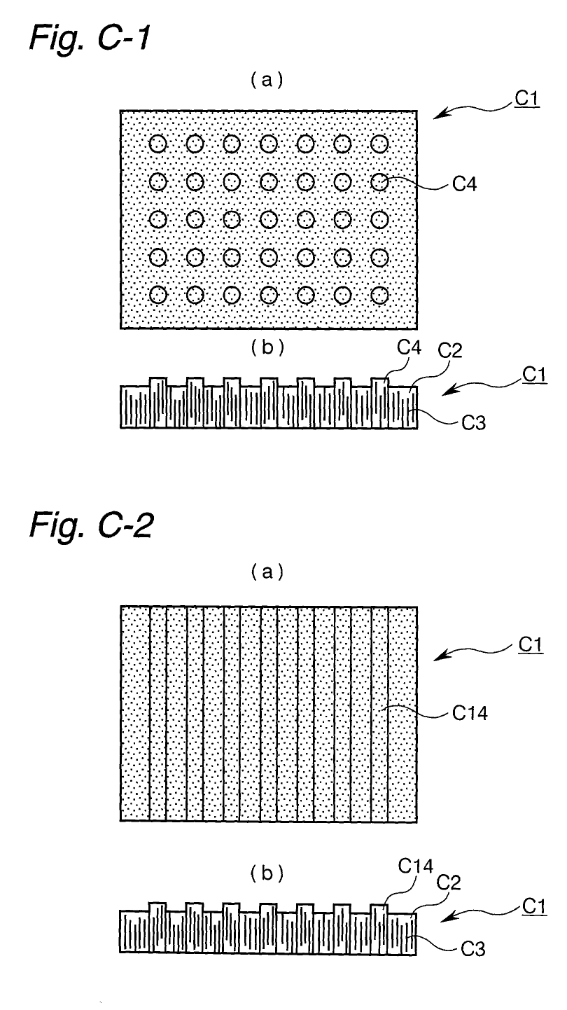

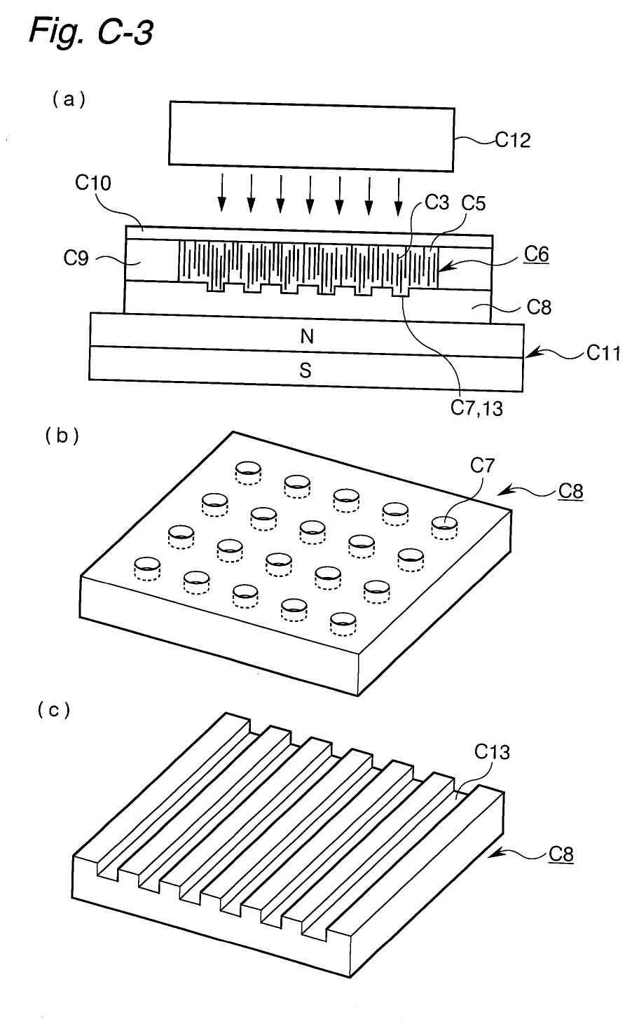

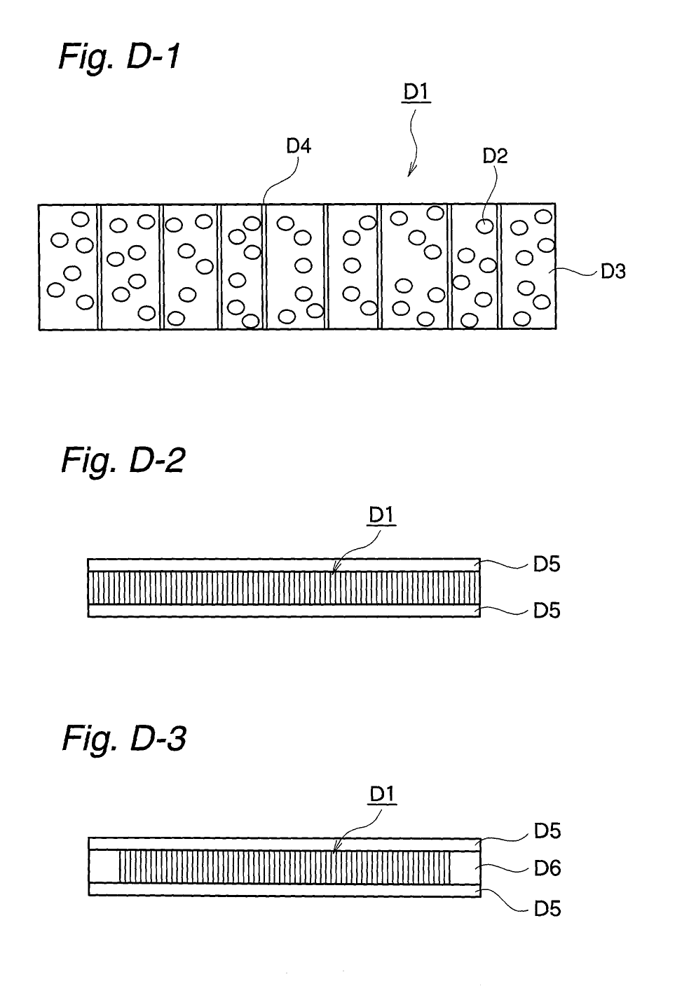

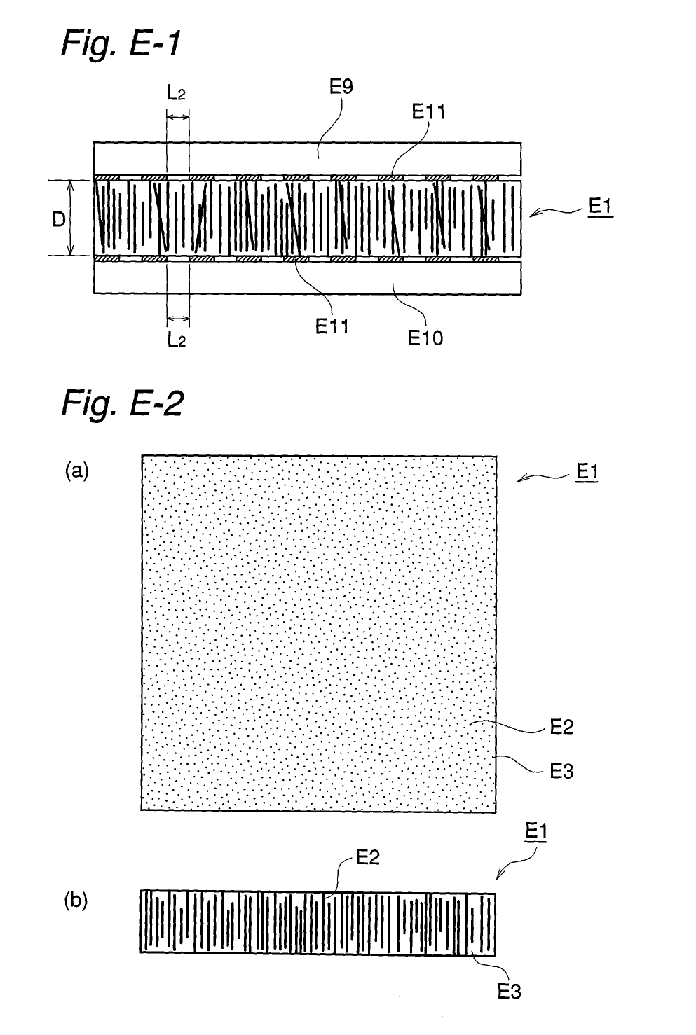

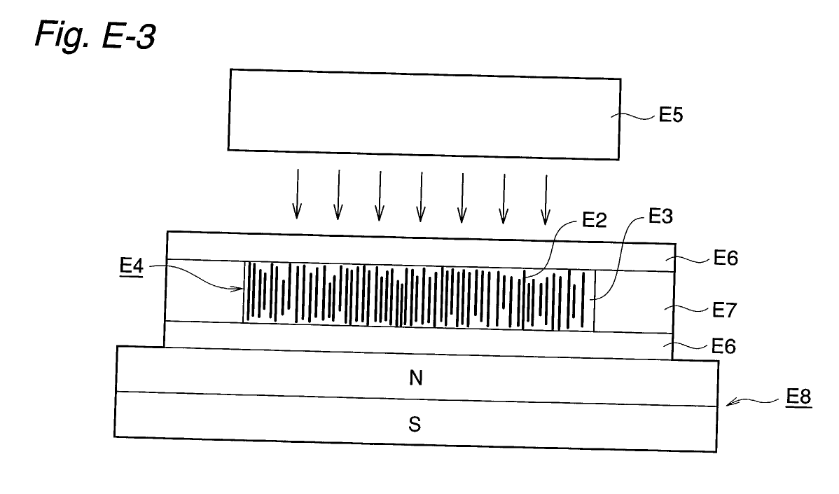

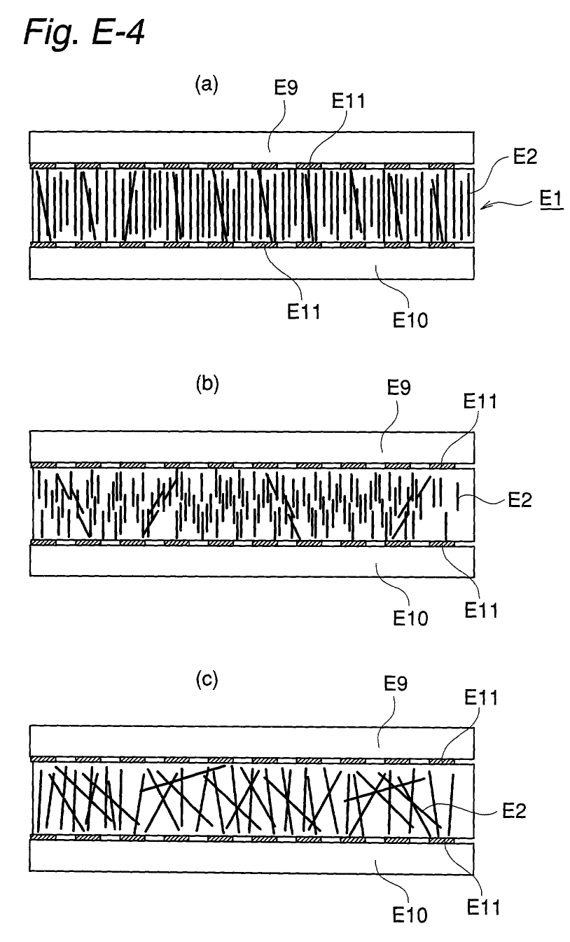

### FIELD OF THE INVENTION

The present invention relates to a composition for composite sheet, a composite sheet, a process for producing the same and a use of the composite sheet. More particularly, the present invention relates to a composite sheet which can be used as a sheet having anisotropic electric conductivity or anisotropic thermal conductivity, a process for producing the same and a use of the composite sheet.

### BACKGROUND OF THE INVENTION

In recent years, the number of electrodes for use in each semiconductor element is increasing in accordance with the trend toward high performance, miniaturization and high-density wiring with regard to electrical or electronic equipment. Thus, as for electrical circuit parts, electrical circuit substrates and the like, the inspection, measuring and electrical connection therebetween are now carried out through minute inter-electrode pitch. And there is a trend toward further reduction of the electrode pitch of semiconductor elements. Therefore, in the mounting of semiconductor elements on substrates and inspection thereof, it is an important task to accomplish a secure low-resistance connection through reduced electrode pitches without short circuit.

Accordingly, attempts have been made to develop an anisotropic conductive sheet capable of attaining compact electrical connection without resort to means such as soldering or mechanical fitting and capable of absorbing mechanical shock or strain to thereby enable realizing soft connection. For example, Japanese Patent Publication No. 56(1981)-48951 and Japanese Patent Laid-open Publication Nos. 51(1976)-93393, 53(1978)-147772 and 54(1979)-146873 describe an anisotropic conductive sheet which exhibits conductivity only in the direction of the thickness of the sheet, and anisotropic conductive sheets of various structures having a multiplicity of conductive parts capable of exhibiting conductivity only in the direction of the thickness when pressurized. Such an anisotropic conductivity is advantageous in that secure electrical connection can be accomplished at the time of, for example, electrical inspection of a circuit substrate or the like without damaging electrodes. In particular, an anisotropic conductive sheet comprising a resin and, contained therein, conductive particles wherein the conductive particles are orientated in the direction of the thickness of the sheet so as to form conductive parts is especially useful in the connection of reduced electrode pitches.

However, in conformity with the requirement for further reduction of electrode size or inter-electrode dimension and for further density increase with respect to an electronic circuit substrate and the like, there is a demand for further reduction of the size of conductive parts of such an anisotropic conductive sheet.

For example, although the conductive part pitch of a semiconductor element and the like has been about 500 μm, an electronic circuit substrate of 100 μm or less pitch has now been developed. There is a trend toward further reduction of the conductive part electrode pitch of a semiconductor element and the like Thus, for realizing accurate and secure electrical connection between conductive parts of an anisotropic conductive sheet which are formed by, for example, orientation of magnetic substance particles in the direction of the thickness of the sheet and conductive parts of a semiconductor element and the like, it is now requisite that the interval of conductive parts of an anisotropic conductive sheet be reduced to, for example, about tens of microns (μm) so as to attain a high density of conductive parts.

Accordingly, attempts have been made to develop an anisotropic conductive sheet comprising a resin and, contained therein, conductive particles wherein the conductive particles are orientated in the direction of the thickness of the sheet to thereby form conductive parts and wherein an improvement is made by reducing the size of orientated conductive particles per se.

However, this anisotropic conductive sheet whose conductive part pitch is reduced by the employment of conductive particles of reduced size has a drawback in that the contact resistance between conductive particles orientated in the direction of the thickness of the anisotropic conductive sheet is increased as a result of the reduction of the size of conductive particles to thereby cause conductivity lowering. Further, this anisotropic conductive sheet has a drawback in that, although the orientation of conductive particles at the time of shaping of anisotropic conductive sheet is an important factor in the increase of conductive part density in anisotropic conductive sheets, the frequency of mutual contact of conductive parts consisting of columns of conductive particles orientated in the direction of the thickness is increased because of a problem of orientation precision with the result that the insulation in a direction perpendicular to the thickness of the sheet may be lowered. For minimizing the above contact resistance between conductive particles of reduced size and for minimizing the above contact of conductive parts to each other, reduction of the thickness of the anisotropic conductive sheet has been attempted. However, the thickness reduction causes a problem such that not only would mathematical dispersion of conductive sheet thickness and sheet strain occur but also the durability of the anisotropic conductive sheet is deteriorated. (Common problem).

On the other hand, when a semiconductor package is assembled in an electronic device or other product and brought to practical use, it may occur that, in accordance with the use of the electronic device or other product, the semiconductor package is vibrated or shocked by external force, or semiconductor elements have irregular heat build-up for a prolonged period of time, so that the adherence of resin sheet interposed between semiconductor elements and circuit substrate, etc. is lowered. Therefore, it is required for the conductive sheet for electrically connecting semiconductor elements and circuit substrate, etc. to each other not only to have high conductivity but also to bond semiconductor elements and circuit substrate, etc to each other with satisfactory strength to resist, for example, vibration from outside instead of simple adhesion thereof to each other.

The method of applying an adhesive containing a conductive filler to a bonding surface and curing the adhesive and the method of interposing a sheet wherein an adherent epoxy resin is used as a binder have been examined in order to enhance the adherence to such semiconductor elements and circuit substrate. However, in the former method, it is difficult to perform accurate application onto minute semiconductor element electrodes. In the latter method, it is needed to provide a sheet thermally cured to such a semi-cured state that the configuration and adherence can be maintained and to carry out further thermal curing of the sheet, so that strict control of curing conditions is requisite. Thus, the latter method has a drawback in that the process is complex and lacks simplicity.

Therefore, there is a demand for the development of a conductive sheet which has high conductivity and is excellent in handlability before and during the production of semiconductor package and which exhibits excellent adherence between semiconductor elements or the like and a circuit substrate or the like after the production of semiconductor package. (First problem)

Furthermore, there is a demand for the development of an anisotropic conductive sheet wherein minute conductive parts are arranged at desired positions with high accuracy so as to be able to meet the further reduction of conductive part pitch. (Second problem).

Still further, in the use of an anisotropic conductive sheet in the inspection, measuring and mutual electrical connection of electrical circuit parts, electrical circuit substrates and the like, there is a problem such that, because of a height difference between an electrode part and, for example, a resist for preventing short circuits on a circuit substrate, it is difficult to attain stable contact therebetween. (Third problem).

Still further, there is a demand for resolution of the phenomenon that, when an extremely large load is imposed in error, especially when loading is repeated, on an anisotropic conductive sheet, even if, in regular use, the anisotropic conductive sheet has no problem in anisotropic conductivity, the insulation in a direction perpendicular to the thickness of the sheet is suddenly lowered. (Fourth problem).

### OBJECT OF THE INVENTION

The first object of the present invention is to resolve the above common problem and first problem of the prior art, specifically to provide an anisotropic conductive sheet wherein the conductive part density can be increased and the conductive parts have low resistance and exhibit high anisotropic conductivity in the thickness direction and which ensures easy handling during the production of semiconductor package and is excellent in adherence after packaging and also to provide a semi-cured anisotropic conductive sheet capable of providing the above anisotropic conductive sheet.

The first object is further to provide a method of using a sheet and a contact structure wherein such a semi-cured anisotropic conductive sheet is employed.

The second object of the present invention is to resolve the above common problem and second problem of the prior art, specifically to provide a composite sheet wherein a magnetic fibrous filler is orientated in the direction of the thickness of the sheet and forms bundles at given positions in a direction of sheet surface. Also, the second object is to provide a process for producing an anisotropic conductive sheet wherein the density of conductive parts constituted of a fibrous filler can be increased and the conductive parts have low resistance and exhibit high anisotropic conductivity in the thickness direction and which is excellent in heat resistance, durability, mechanical strength and adherence to semiconductor elements and to provide an anisotropic conductive sheet obtained by the above process. The second object is further to provide a heat-conductive sheet obtained by a similar process.

The third object of the present invention is to resolve the above common problem and third problem of the prior art, specifically to provide a composite sheet wherein a magnetic fibrous filler is orientated in the direction of the thickness of the sheet and which has projections on at least one side thereof. Also, the third object is to provide a process for producing an anisotropic conductive sheet wherein the conductive parts have low resistance and exhibit high anisotropic conductivity in the thickness direction and which is excellent in heat resistance, durability, mechanical strength and stability of connection to electrode parts of semiconductor elements and to provide an anisotropic conductive sheet obtained by the above process. The third object is further to provide a heat-conductive composite sheet obtained by a similar process.

The fourth object of the present invention is to resolve the above common problem and fourth problem of the prior art, specifically to provide a composite sheet having anisotropic conductivity wherein, even if an extremely large load is imposed, the lowering of insulation in a direction perpendicular to the thickness of the sheet is inhibited and wherein a fibrous filler is orientated in the direction of the thickness of the sheet.

Also, the fourth object is to provide an anisotropic conductive sheet wherein the conductive parts have low resistance and exhibit high anisotropic conductivity in the direction of the thickness of the sheet and which is excellent in heat resistance, durability, mechanical strength and stability of connection to electrode parts of semiconductor elements. The fourth object is further to provide an anisotropic conductive sheet having high thermal conductivity.

The fifth object of the present invention is to resolve the above common problem of the prior art, specifically to provide an anisotropic conductive sheet which enables stable electrical connection with minute electrodes and which is excellent in not only a balance of conduction resistance in the direction of sheet thickness and insulation in the direction perpendicular to the thickness of the sheet but also heat resistance, durability, mechanical strength and stability of connection to electrode parts of semiconductor elements.

### SUMMARY OF THE INVENTION

The inventors have made extensive and intensive studies with a view toward resolving the above common problem and first problem. As a result, it has been found that, when use is made of a composition for conductive sheet comprising a binder being composed of a photocuring component and a thermosetting component and, contained therein, a fibrous filler having both conductivity and magnetism, the fibrous filler is orientated in the direction of sheet thickness by application of a magnetic field, and the photocuring component is cured by light irradiation, with the result that a semi-cured conductive sheet wherein the highly adherent thermosetting component is contained in uncured form can be obtained.

Also, it has been found that, when the thermosetting component contained in the uncured conductive sheet is cured by, for example, thermocompression in the process for producing a semiconductor package or the like, the obtained conductive sheet can exhibit excellent adherence. It has further been found that, in this conductive sheet, not only can the conductive part pitch of the conductive sheet be reduced but also the contact resistance between conductive particles can be conspicuously lowered, to thereby enable increasing the thickness of anisotropic conductive sheet while maintaining its low resistance and enable obtaining the sheet which is excellent in the conductivity in the direction of the thickness thereof. The first invention of the present application has been completed on the basis of these findings. (First invention).

Moreover, the inventors have made extensive and intensive studies with a view toward resolving the above common problem and second problem. As a result, it has been found that an anisotropic conductive sheet comprising a cured or semi-cured binder and, contained therein, a fibrous filler having a magnetic substance and a noble metal adhering thereto on its surface, the fibrous filler orientated in the direction of the thickness of the sheet and formed into bundles localized at given positions of the sheet, enables reducing the conductive part pitch of anisotropic conductive sheet while placing conductive parts of the fibrous filler at desired positions with high accuracy. It has also been found that the conductive parts of fibrous filler, as compared with conductive parts of conductive particles, enable effectively reducing the contact resistance between conductive particles, so that not only can the thickness of anisotropic conductive sheet be increased while maintaining its low resistance but also the sheet having excellent conductivity in the direction of the thickness of the sheet can be obtained. It has further been found that this anisotropic conductive sheet is excellent in adherence to semiconductor elements as well as heat resistance, durability and mechanical strength, and that excellent thermal conductivity can simultaneously be exhibited by the use of a filler having high thermal conductivity in the direction of fiber length as the magnetic fibrous filler. The second invention of the present application has been completed on the basis of these findings. (Second invention).

Furthermore, the inventors have made extensive and intensive studies with a view toward resolving the above third problem. As a result, it has been found that a composite sheet having projections on at least one side thereof and comprising a cured or semi-cured binder and, contained therein, a fibrous filler having a magnetic substance adhering thereto on its surface, the fibrous filler orientated in the direction of the thickness of the sheet and further having a noble metal adhering thereto on its surface, enables stable electrical connection with minute electrodes even if the electrodes have height differences from a resist, etc. It has also been found that the conductive parts of fibrous filler, as compared with conductive parts of conductive particles, enable effectively reducing the contact resistance between conductive matters, so that not only can the thickness of anisotropic conductive sheet be increased while maintaining its low resistance but also the sheet having excellent conductivity in the direction of the thickness of the sheet can be obtained. It has further been found that this anisotropic conductive sheet is excellent in adherence to semiconductor elements as well as heat resistance, durability and mechanical strength, and that excellent thermal conductivity can simultaneously be exhibited by the use of a filler having high thermal conductivity in the direction of fiber length as a magnetic fibrous filler. The third invention of the present application has been completed on the basis of these findings. (Third invention).

Still further, the inventors have made extensive and intensive studies with a view toward resolving the above fourth problem. As a result, it has been found that, when an extremely large load is imposed, micro-rupture of binder occurs between mutually neighboring fillers having been insulated from each other to thereby deteriorate the insulation. In this connection, it has been found that appropriately dispersing fine particles in the binder filling the interstices between mutually neighboring fillers, as a countermeasure, enables inhibiting the insulation deterioration.

It has further been found that this anisotropic conductive sheet is excellent in adherence to semiconductor elements as well as heat resistance and mechanical strength, and that excellent thermal conductivity can simultaneously be exhibited by the use of a filler having high thermal conductivity in the direction of fiber length as a magnetic fibrous filler and by the use of insulating inorganic fine particles having high thermal conductivity as the fine particles, thereby ensuring effective contribution to the resolution of the problem of malfunction attributed to heat build-up at the time of semiconductor element driving. The fourth invention of the present application has been completed on the basis of these findings. (Fourth invention).

Still further, the inventors have made extensive and intensive studies with a view toward resolving the above common problem. As a result, it has been found that, when a fibrous filler with conductivity and magnetism contained in an anisotropic conductive sheet is orientated in the direction of the thickness of the sheet and when, with respect to at least a certain proportion of the fibrous filler, the fiber length of fibrous filler, thickness of anisotropic conductive sheet and minimum distance between neighboring electrodes on a semiconductor element and a circuit substrate satisfy a given relationship, not only can stable electric connection be effected for minute electrodes but also the problem of short circuit between mutually neighboring electrodes can be resolved to a great extent without the sacrifice of conduction resistance in the direction of the thickness of the sheet. It has also been found that this anisotropic conductive sheet is excellent in adherence to semiconductor elements as well as heat resistance, durability and mechanical strength. The fifth invention of the present application has been completed on the basis of these findings. (Fifth invention).

Therefore, according to the present invention, there are provided the following first to fifth inventions.

(First Invention)

The composition for composite sheet according to the first invention comprises a magnetic fibrous filler (A) and a binder (B), the binder (B) comprising a photocuring component and a thermosetting component.

Further, according to the first invention, there is provided a composite sheet of given thickness in semi-cured form, comprising a semi-cured binder (B1) and, incorporated therein, a magnetic fibrous filler (A),

the semi-cured binder (B1) comprising a thermosetting component and a component resulting from curing of a photocuring component,

the magnetic fibrous filler (A) orientated in the direction of the thickness of the semi-cured composite sheet.

The photocuring component is preferably a (meth)acrylic compound. The thermosetting component is preferably an epoxy compound.

The magnetic fibrous filler (A) is preferably a fibrous filler having both conductivity and magnetism.

It is preferred that the fibrous filler having both conductivity and magnetism be constituted of a magnetic fibrous filler having a noble metal adhering thereto on its surface.

It is also preferred that the fibrous filler having both conductivity and magnetism be constituted of at least one member selected from the group consisting of a metallic fiber having magnetism, a fiber having magnetic susceptibilities in a direction of fiber axis and in a direction of fiber circumference which are different from each other and a fiber having a magnetic substance adhering thereto on its surface.

The fiber having magnetic susceptibilities in a direction of fiber axis and in a direction of fiber circumference which are different from each other is preferably a carbon fiber.

The magnetic fibrous filler (A) is preferably constituted of a fiber having a magnetic substance adhering thereto on its surface.

The composite sheet is preferably an anisotropic conductive sheet.

Still further, according to the first invention, there is provided a composite sheet of given thickness in cured form, comprising a binder (B2) and, incorporated therein, a magnetic fibrous filler (A),

the binder (B2) comprising a component resulting from curing of a thermosetting component and a component resulting from curing of a photocuring component,

the magnetic fibrous filler (A) orientated in the direction of the thickness of the cured composite sheet.

The process for producing a composite sheet in semi-cured form according to the first invention comprises the steps of:

sheeting a composition for composite sheet into a sheet of given thickness, the composition comprising a magnetic fibrous filler (A) and a binder (B), the binder (B) comprising a photocuring component and a thermosetting component, and

not only applying a magnetic field to the composition sheet in the direction of the thickness of the composition sheet so as to orientate the magnetic fibrous filler (A) in the direction of the thickness of the composition sheet but also curing the photocuring component of the sheeted composition, thereby obtaining a semi-cured composite sheet.

Furthermore, according to the first invention, there is provided a method of using a composite sheet, the composite sheet being one of given thickness in semi-cured form comprising a semi-cured binder (B1) and, incorporated therein, a magnetic fibrous filler (A), the semi-cured binder (B1) comprising a thermosetting component and a component resulting from curing of a photocuring component, the magnetic fibrous filler (A) orientated in the direction of the thickness of the semi-cured composite sheet,

which method comprises the steps of:

interposing the semi-cured composite sheet between an electrode part of a semiconductor element or semiconductor package and a wiring part of a circuit substrate, and

curing the thermosetting component of the semi-cured composite sheet to thereby convert the semi-cured composite sheet to a cured composite sheet so that the electrode part and the wiring part are electrically connected to each other.

The contact structure of the first invention comprises an electrode part of a semiconductor element or semiconductor package and a wiring part of a circuit substrate and, interposed therebetween so as to electrically connect them to each other, a composite sheet, the composite sheet being one of given thickness in cured form comprising a binder (B2) and, incorporated therein, a magnetic fibrous filler (A), the binder (B2) comprising a component resulting from curing of a thermosetting component and a component resulting from curing of a photocuring component, the magnetic fibrous filler (A) orientated in the direction of the thickness of the cured composite sheet.

(Second Invention)

According to the second invention, there is provided a composite sheet of given thickness comprising a binder and a magnetic fibrous filler (A), the magnetic fibrous filler (A) orientated in the binder in the direction of the thickness of the composite sheet, the orientated magnetic fibrous filler (A) forming a plurality of bundles.

The bundles of the magnetic fibrous filler (A) orientated in the direction of the thickness of the composite sheet may be arranged in striped form in a direction of sheet surface.

The bundles of the magnetic fibrous filler (A) orientated in the direction of the thickness of the composite sheet may be arranged in islanded form in a direction of sheet surface.

The process for producing a composite sheet according to the second invention comprises the steps of:

interposing a sheeted composition of given thickness comprising a magnetic fibrous filler (A) and a thermosetting and/or photocuring binder (B) between a pair of magnetic pole plates each having on its surface projected magnetic pole surface portions, and

not only applying a magnetic field parallel to the direction of the thickness of the sheet to the sheeted composition so that the magnetic fibrous fillers (A), while being orientated in the direction of the thickness of the sheet, are bundled in the vicinity of projected magnetic pole surface portions of the magnetic pole plates but also curing the binder (B) by heating and/or light irradiation.

The magnetic fibrous filler (A) is preferably a conductive filler having a noble metal adhering thereto on its surface.

The magnetic fibrous filler (A) preferably has a thermal conductivity of 100 W^{●}m⁻¹^{●}K⁻¹ or greater in a direction of fiber length.

It is preferred that the magnetic fibrous filler (A) be constituted of at least one member selected from the group consisting of a metallic fiber having magnetism, a fiber having magnetic susceptibilities in a direction of fiber axis and in a direction of fiber circumference which are different from each other and a fiber having a magnetic substance adhering thereto on its surface.

It is preferred that the fiber having magnetic susceptibilities in a direction of fiber axis and in a direction of fiber circumference-which are different from each other be a carbon fiber.

The magnetic fibrous filler (A) is preferably constituted of a fiber having a magnetic substance adhering thereto on its surface.

Preferably, the projections of the magnetic pole plates each having on its surface projected magnetic pole surface portions are a plurality of projections arranged in the form of stripes parallel to each other or projections arranged in the form of islands with given spacings.

The magnetic pole plates each having on its surface projected magnetic pole surface portions preferably have concave portions filled with a nonmagnetic material so that the surfaces of the magnetic pole plates are planar.

Also, preferably, the magnetic pole plates each having on its surface projected magnetic pole surface portions have concave portions filled with a nonmagnetic material so that the surfaces of the magnetic pole plates are planar, and projections of given configuration constituted of a nonmagnetic material are further anchored or adhered onto the magnetic pole plate surfaces.

(Third Invention)

According to the third invention, there is provided a composite sheet of given thickness comprising a binder and a magnetic fibrous filler (A), the magnetic fibrous filler (A) orientated in the binder in the direction of the thickness of the composite sheet, the composite sheet having projections on at least one side thereof.

The projections on at least one side of the composite sheet are preferably arranged in striped form in a direction of sheet surface.

Also, the projections on at least one side of the composite sheet are preferably arranged in islanded form in a direction of sheet surface.

The process for producing a composite sheet according to the third invention comprises the steps of:

bringing at least one side of a sheeted composition of given thickness comprising a magnetic fibrous filler (A) and a thermosetting and/or photocuring binder (B) into contact with a surface of nonmagnetic substance having a plurality of concaves, and

not only applying a magnetic field parallel to the direction of the thickness of the sheet to the sheeted composition so that the magnetic fibrous filler (A) is orientated in the direction of the thickness of the sheet but also curing the binder (B) by heating and/or light irradiation to thereby obtain a composite sheet having a plurality of projections on at least one side thereof.

The magnetic fibrous filler (A) is preferably a conductive filler having a noble metal adhering thereto on its surface.

The magnetic fibrous filler (A) preferably has a thermal conductivity of 100 W^{●}m⁻¹^{●}K⁻¹ or greater in a direction of fiber length.

It is preferred that the magnetic fibrous filler (A) be constituted of at least one member selected from the group consisting of a metallic fiber having magnetism, a fiber having magnetic susceptibilities in a direction of fiber axis and in a direction of fiber circumference which are different from each other and a fiber having a magnetic substance adhering thereto on its surface.

The fiber having magnetic susceptibilities in a direction of fiber axis and in a direction of fiber circumference which are different from each other is preferably a carbon fiber.

The magnetic fibrous filler (A) is preferably constituted of a fiber having a magnetic substance adhering thereto on its surface.

Preferably, the concaves of the surface of nonmagnetic substance having a plurality of concaves are arranged in the form of stripes parallel to each other or arranged in the form of islands with given spacings.

The composite sheet is preferably an anisotropic electricity-conductive sheet.

The composite sheet may be an anisotropic heat-conductive sheet.

(Fourth Invention)

According to the fourth invention, there is provided a composite sheet of given thickness comprising a magnetic fibrous filler (A), a binder cured by heating and/or light irradiation, and organic fine particles or inorganic fine particles (C), the magnetic fibrous filler (A) orientated in the direction of the thickness of the composite sheet.

It is preferred that the magnetic fibrous filler (A) be constituted of at least one member selected from the group consisting of a metallic fiber having magnetism, a fiber having magnetic susceptibilities in a direction of fiber axis and in a direction of fiber circumference which are different from each other and a fiber having a magnetic substance adhering thereto on its surface.

Preferably, the magnetic fibrous filler (A) is a conductive filler having a noble metal adhering thereto on its surface, and the organic fine particles or inorganic fine particles (C) are insulators.

The organic fine particles or inorganic fine particles (C) preferably constitute insulating fine particles having an average diameter of 1 to 100 μm.

The volume ratio of insulating fine particles composed of the organic fine particles or inorganic fine particles (C) in the composite sheet is preferably in the range of 2 to 50%.

It is preferred that the magnetic fibrous filler (A) have a thermal conductivity of 100 W^{●}m⁻¹^{●}K⁻¹ or greater in a direction of fiber length, and that the organic fine particles or inorganic fine particles (C) also have a thermal conductivity of 100 W^{●}m⁻¹^{●}K⁻¹ or greater.

The composite sheet is preferably a sheet having anisotropic electric conductivity.

The composite sheet is also preferably a sheet having anisotropic thermal conductivity and anisotropic electric conductivity.

The process for producing a composite sheet according to the fourth invention comprises the steps of:

sheeting a composition into a sheet of given thickness, the composition comprising a magnetic fibrous filler (A), a thermosetting and/or photocuring binder (B), and organic fine particles or inorganic fine particles (C), and

not only applying a magnetic field to the composition sheet in the direction of the thickness of the composition sheet so as to orientate the magnetic fibrous filler (A) in the direction of the thickness of the composition sheet but also curing the binder (B) by heating and/or light irradiation.

(Fifth Invention)

According to the fifth invention, there is provided a composite sheet of given thickness to be interposed between a semiconductor element and a circuit substrate, comprising a magnetic fibrous filler (A) orientated in the direction of the thickness of the composite sheet, at least 80% of the magnetic fibrous filler (A) having a fiber length L₁ satisfying the relationship:

0.5×D<L₁<(L₂²+D²)^{1/2} (I)

wherein L₁ represents a fiber length of magnetic fibrous filler (A), D represents a thickness of composite sheet, and L₂ represents a minimum distance between neighboring electrodes among neighboring-electrode distances with respect to electrodes arranged on a semiconductor element on its composite sheet side or neighboring-electrode distances with respect to electrodes arranged on a circuit substrate on its composite sheet side.

The magnetic fibrous filler (A) is preferably a fibrous filler having both conductivity and magnetism.

The composite sheet is preferably produced by a process comprising the steps of:

sheeting a composition into a sheet of given thickness, the composition comprising a fibrous filler having both conductivity and magnetism and a thermosetting and/or photocuring binder (B), and

not only applying a magnetic field to the composition sheet in the direction of the thickness of the composition sheet so as to orientate the fibrous filler having both conductivity and magnetism in the direction of the thickness of the composition sheet but also curing the binder (B) by heating and/or light irradiation.

The fibrous filler having both conductivity and magnetism is preferably constituted of a magnetic fibrous filler having a noble metal adhering thereto on its surface.

It is preferred that the fibrous filler having both conductivity and magnetism be constituted of at least one member selected from the group consisting of a metallic fiber having magnetism, a fiber having magnetic susceptibilities in a direction of fiber axis and in a direction of fiber circumference which are different from each other and a fiber having a magnetic substance adhering thereto on its surface.

The fiber having magnetic susceptibilities in a direction of fiber axis and in a direction of fiber circumference which are different from each other is preferably a carbon fiber.

Preferably, the fibrous filler having both conductivity and magnetism (A1) is constituted of a fiber having a magnetic substance adhering thereto on its surface.

It is preferred that the composite sheet be an anisotropic conductive sheet.

The method of using a composite sheet according to the fifth invention comprises electrically connecting an electrode of a semiconductor element and an electrode of a circuit substrate to each other through each of the above composite sheets.

### BRIEF DESCRIPTION OF THE DRAWING

FIG. A-1 is a schematic sectional view of a composite sheet containing a fiber having a magnetic substance and a noble metal adhering thereto on its surface;

FIG. A-2 is a schematic sectional view of a composite sheet covered with protective films;

FIG. A-3 is a schematic sectional view of a composite sheet provided with a spacer and covered with protective films;

FIG. A-4 is a schematic view of a contact structure;

FIG. B-1(a) is a stereoscopic schematic view of a composite sheet wherein a magnetic fibrous filler is orientated in the direction of the thickness of the sheet and wherein the fibrous filler is bundled in islanded form, as taken from the sheet surface side;

FIG. B-1(b) is a schematic sectional view, taken in the direction of the arrow substantially along the line a-a of FIG. B-1(a), of a composite sheet wherein a magnetic fibrous filler is orientated in the direction of the thickness of the sheet and wherein the fibrous filler is localized and distributed in islanded form;

FIG. B-2(a) is a stereoscopic schematic view of a composite sheet wherein a magnetic fibrous filler is orientated in the direction of the thickness of the sheet and wherein the fibrous filler is bundled in striped form, as taken from the sheet surface side;

FIG. B-2(b) is a schematic sectional view, taken in the direction of the arrow substantially along the line b-b of FIG. B-2(a), of a composite sheet wherein a magnetic fibrous filler is orientated in the direction of the thickness of the sheet and wherein the fibrous filler is localized and distributed in striped form;

FIG. B-3(a) is a schematic sectional view of an apparatus for producing a composite sheet;

FIG. B-3(b) is a schematic view of a magnetic substance plate for use in the above apparatus;

FIG. B-3(c) is a schematic view of a magnetic substance plate for use in the above apparatus;

FIG. B-4 is a view showing a method of measuring a thermal conductivity according to the thermal alternating current method;

FIG. B-5 is a view showing a phase difference of temperature exhibited in the above method of measuring a thermal conductivity according to the thermal alternating current method;

FIG. C-1(a) is a plan of a composite sheet having islanded projections on one side of the sheet, wherein a magnetic fibrous filler is orientated in the direction of the thickness of the sheet, as viewed from the projection side;

FIG. C-1(b) is a section of a composite sheet having islanded projections on one side of the sheet, wherein a magnetic fibrous filler is orientated in the direction of the thickness of the sheet, as viewed from a position parallel to a sheet surface;

FIG. C-2(a) is a plan of a composite sheet having striped projections on one side of the sheet, wherein a magnetic fibrous filler is orientated in the direction of the thickness of the sheet, as viewed from the projection side;

FIG. C-2(b) is a section of a composite sheet having striped projections on one side of the sheet, wherein a magnetic fibrous filler is orientated in the direction of the thickness of the sheet, as viewed from a position parallel to a sheet surface;

FIG. C-3(a) is a schematic view showing one mode of process for producing a composite sheet;

FIG. C-3(b) is a schematic view of a nonmagnetic substance plate having islanded concaves for use in projection formation;

FIG. C-3(c) is a schematic view of a nonmagnetic substance plate having striped concaves for use in projection formation;

FIG. D-1 is a schematic sectional view of a composite sheet having anisotropic conductivity wherein a fibrous filler having a magnetic substance and a noble metal adhering thereto on its surface is orientated in the direction of the thickness of the sheet in a binder in which organic fine particles or inorganic fine particles are dispersed;

FIG. D-2 is a schematic sectional view of a composite sheet covered with protective films;

FIG. D-3 is a schematic sectional view of a composite sheet provided with a spacer and covered with protective films;

FIG. E-1 is a schematic sectional view of a structure comprising a circuit substrate and a semiconductor element furnished with electrodes and, interposed therebetween, an anisotropic conductive sheet;

FIG. E-2(a) is a plan of an anisotropic conductive sheet wherein a fibrous filler having both conductivity and magnetism is orientated in the direction of the thickness of the sheet, as viewed from a position perpendicular to a sheet surface;

FIG. E-2(b) is a section of an anisotropic conductive sheet wherein a fibrous filler having both conductivity and magnetism is orientated in the direction of the thickness of the sheet, as viewed from a position parallel to a sheet surface;

FIG. E-3 is a schematic view showing one mode of process for producing an anisotropic conductive sheet;

FIG. E-4(a) is a schematic view showing one mode of usage of an anisotropic conductive sheet wherein a filler comprising a fiber whose length is as specified in the present invention is employed;

FIG. E-4(b) is a schematic view showing one mode of usage of an anisotropic conductive sheet wherein a filler comprising a fiber whose length is smaller than that specified in the present invention is employed; and

FIG. E-4(c) is a schematic view showing one mode of usage of an anisotropic conductive sheet wherein a filler comprising a fiber whose length is larger than that specified in the present invention is employed.

### DETAILED DESCRIPTION OF THE INVENTION

The composite sheet of the first invention is formed from a composition for composite sheet, which composite sheet is one of given thickness in semi-cured form, comprising a semi-cured binder (B1) and, incorporated therein, a magnetic fibrous filler (A),

the semi-cured binder (B1) comprising a thermosetting component and a component resulting from curing of a photocuring component,

the magnetic fibrous filler (A) orientated in the direction of the thickness of the semi-cured composite sheet. The composite sheet is, for example, a sheet having anisotropic electric conductivity or anisotropic thermal conductivity, which is cured before application by, for example, thermocompression in the process for producing a semiconductor package.

The composite sheet of the second invention is one of given thickness comprising a binder and a magnetic fibrous filler (A), the magnetic fibrous filler (A) orientated in the binder in the direction of the thickness of the composite sheet, the orientated magnetic fibrous filler (A) constituting a plurality of bundles. The composite sheet is, for example, a sheet having anisotropic electric conductivity or anisotropic thermal conductivity.

The composite sheet of the second invention can be obtained by the process comprising the steps of:

interposing a sheeted composition of given thickness comprising a magnetic fibrous filler (A) and a thermosetting and/or photocuring binder (B) between a pair of magnetic pole plates each having on its surface projected magnetic pole surface portions for localizing a magnetic field, and

not only applying a magnetic field parallel to the direction of the thickness of the sheet to the sheeted composition so that the magnetic fibrous filler (A), while being orientated in the direction of the thickness of the sheet, is bundled in the vicinity of projected magnetic pole surface portions of the magnetic pole plates but also curing the binder (B) by heating and/or light irradiation. When the magnetic fibrous filler has high electric conductivity, the process enables effectively producing the composite sheet with anisotropic electric conductivity. On the other hand, when the magnetic fibrous filler has high thermal conductivity in the direction of fiber length, the process enables effectively producing the heat-conductive composite sheet.

The composite sheet of the third invention is one of given thickness comprising a binder and a magnetic fibrous filler (A), the magnetic-fibrous filler (A) orientated in the binder in the direction of the thickness of the composite sheet, the composite sheet having projections on at least one side thereof. The composite sheet is, for example, a sheet having anisotropic electric conductivity or anisotropic thermal conductivity.

The composite sheet of the third invention can be obtained by the process comprising the steps of:

bringing at least one side of a sheeted composition of given thickness comprising a magnetic fibrous filler (A) and a thermosetting and/or photocuring binder (B) into contact with a surface of nonmagnetic substance plate having a plurality of concaves, and

not only applying a magnetic field parallel to the direction of the thickness of the sheet to the sheeted composition so that the magnetic fibrous filler (A) is orientated in the direction of the thickness of the sheet but also curing or semi-curing the binder (B) by heating and/or light irradiation. When the magnetic fibrous filler has high electric conductivity, the process enables effectively producing the composite sheet with anisotropic electric conductivity. On the other hand, when the magnetic fibrous filler has high thermal conductivity in the direction of fiber length, the process enables effectively producing the heat-conductive composite sheet.

The composite sheet of the fourth invention is one of given thickness comprising a magnetic fibrous filler (A), a binder cured by heating and/or light irradiation (B), and organic fine particles or inorganic fine particles (C), the magnetic fibrous filler (A) orientated in the direction of the thickness of the composite sheet in the binder (B). The sheet with anisotropic conductivity or with anisotropic conductivity and anisotropic thermal conductivity can be obtained by selecting appropriate fibrous filler. That is, when the magnetic fibrous filler has high electric conductivity, there is provided the composite sheet with anisotropic electric conductivity. On the other hand, when the magnetic fibrous filler further has high thermal conductivity in the direction of fiber length, there is provided the composite sheet with not only electric conductivity but also thermal conductivity.

The composite sheet of the fourth invention can be obtained by the process comprising the steps of:

sheeting a composition into a sheet of given thickness, the composition comprising a magnetic fibrous filler (A), a thermosetting and/or photocuring binder (B), and organic fine particles or inorganic fine particles (C), and

not only applying a magnetic field parallel to the direction of the thickness of the sheet to the composition sheet so as to orientate the magnetic fibrous filler (A) in the direction of the thickness of the composition sheet but also curing or semi-curing the binder (B) by heating and/or light irradiation.

The composite sheet of the fifth invention is one of given thickness to be interposed between a semiconductor element and a circuit substrate in order to effect electrical connection between an electrode of semiconductor element and an electrode of circuit substrate, comprising a magnetic fibrous filler (A) orientated in the direction of the thickness of the composite sheet, at least 80% of the magnetic fibrous filler (A) having a fiber length L₁ satisfying the relationship:

0.5×D<L₁<(L₂²+D²)^{1/2} (I).

The composite sheet is, for example, a sheet having anisotropic electric conductivity or anisotropic thermal conductivity.

In the above formula, L₁ represents a fiber length of magnetic fibrous filler (A), D represents a thickness of composite sheet, and L₂ represents a minimum distance between neighboring electrodes among neighboring-electrode distances with respect to electrodes arranged on a semiconductor element on its composite sheet side or neighboring-electrode distances with respect to electrodes arranged on a circuit substrate on its composite sheet side.

For example, referring to FIG. E-1, the above sheet thickness D is the thickness of anisotropic conductive sheet E1, and the above minimum distance between neighboring electrodes L₂ is a minimum distance between neighboring electrodes with respect to electrodes E11 arranged on a semiconductor element E9 on its composite sheet side or with respect to electrodes E11 arranged on a circuit substrate E10 on its composite sheet side.

The composite sheet of the fifth invention can be produced by:

sheeting a composition into a sheet of given thickness, the composition comprising a magnetic fibrous filler (A) of the fiber length L₁ satisfying the above relationship and a thermosetting and/or photocuring binder (B), and

not only applying a magnetic field to the composition sheet in the direction of the thickness of the composition sheet so as to orientate the magnetic fibrous filler (A) in the direction of the thickness of the composition sheet but also curing the binder (B) by heating and/or light irradiation.

The composition, sheet and productive process according to the first to fifth inventions will be described in detail below.

The terminology “orientated” used herein means that, for example, rod-shaped fibers are arranged in substantially the same direction.

The terminology “composite sheet” used herein means a sheet having anisotropic electric conductivity and/or anisotropic thermal conductivity.

<Composition for Composite Sheet>

The composition for composite sheet according to each of the first, second, third and fifth inventions comprises a binder (B) and a magnetic fibrous filler (A) optionally together with a photoinitiator, a heat curing agent and other additives. The composition for composite sheet according to the fourth invention comprises not only the above but also organic fine particles or inorganic fine particles as an essential component.

Magnetic Fibrous Filler (A)

(Magnetic Fibrous Filler (A))

The “magnetic fibrous filler (A)” for use in the first to fifth inventions is a fibrous filler of given favorable aspect ratio having such a strength, at a given diameter, that, when a magnetic field is applied to the sheeted composition of the present invention, the fiber can be orientated substantially parallel to the direction of the magnetic field without suffering bending or breaking, the fibrous filler further having resistance to heat applied at the time of forming or using the sheet of the present invention according to necessity (for example, having a melting point of 100 ° C. or higher).

As such a magnetic fibrous filler (A), there can be mentioned at least one member selected from the group consisting of a metallic fiber, a fiber having magnetic susceptibilities in a direction of fiber axis and in a direction of fiber circumference which are different from each other and a fiber having a magnetic substance adhering thereto on its surface.

The above metallic fiber can be, for example, a magnetic fiber constituted of a metal such as Fe, Co or Ni which, when wrought into a fiber, exhibits magnetic anisotropy attributed to the configuration, or its alloy or oxide.

The above fiber having magnetic susceptibilities in a direction of fiber axis and in a direction of fiber circumference which are different from each other can be, for example, a fiber, such as a carbon fiber, an aramide fiber or a polyparabenzazole fiber, which easily assumes such a structure that aromatic rings are arranged parallel to the direction of fiber axis, thereby inherently exhibiting magnetic anisotropy.

In particular, the carbon fiber can be selected from among, for example, cellulose, PAN and pitch carbon fibers, in respect of the type of raw material. Of these, the pitch carbon fiber is preferred from the viewpoint of adding excellent electric conductivity and excellent thermal conductivity. With respect to the pitch carbon fiber, both an anisotropic carbon fiber and an isotropic carbon fiber can be used as long as high thermal conductivity is exhibited. The above aramide fiber can be, for example, a fiber of either of poly-p-phenyleneterephthalamide and poly-m-phenyleneisophthalamide. Of these, a fiber of poly-p-phenyleneterephthalamide is preferred. The above polyparabenzazole fiber can be, for example, a fiber of either of poly-p-phenylenebenzobisoxazole and poly-p-phenylenebenzobisthiazole. Of these, a fiber of poly-p-phenylenebenzobisoxazole is preferred.

Besides the fiber having magnetic susceptibilities in a direction of fiber axis and in a direction of fiber circumference which are different from each other such as a carbon fiber, an aramide fiber or a polyparabenzazole fiber, the fiber obtained by causing a magnetic substance such as Fe, Co or Ni to adhere to the above fiber or other fibers can be used as the fibrous filler (A).

The fiber other than the carbon fiber, aramide fiber or polyparabenzazole fiber can be selected from among known regenerated fibers and synthetic fibers. For example, the other fiber can be a regenerated fiber constituted of rayon or the like; a synthetic fiber constituted of an aliphatic polyamide such as nylon-6 or nylon-66, polyethylene terephthalate (PET), polyacrylonitrile (PAN), polyvinyl alcohol (PVA), polypropylene (PP), polyvinyl chloride (PVC) or polyethylene (PE); a fiber constituted of a highly heat resistant polymer such as polyphenylene sulfide (PPS), ultrahigh-molecular-weight polyethylene (UHMWPE) or polyoxymethylene (POM); a fiber constituted of a polymer of high elasticity and high strength such as an aromatic polyamide, a totally aromatic polyester or a polyimide; or a glass fiber.

Of these, from the viewpoint of heat resistance and strength, for example, a totally aromatic polyester, a polyimide and a glass fiber are preferred. A totally aromatic polyester and a polyimide are especially preferred.

With respect to the magnetic substance adhering to the fiber having magnetic susceptibilities in a direction of fiber axis and in a direction of fiber circumference which are different from each other, such as the carbon fiber or aramide fiber, or other fibers, the magnetic substance may be adhered to a whole fiber surface in the form of a layer, or may be adhered to part of a fiber surface without forming a layer, as long as such a magnetism that the orientation can be effected in the direction of magnetic field when a magnetic field is applied by the method described later can be exhibited.

This magnetic substance is preferably a ferromagnetic substance, which can be, for example, any of metals such as iron, cobalt and nickel and alloys of these metals, and further can be any of intermetallic compounds containing ferromagnetic metals such as iron, cobalt and nickel, and oxides or other compounds of such metals.

Although the ferromagnetic substance adhering ratio to fibrous filler surface (adhered area ratio) is not particularly limited as long as such a magnetism that the orientation can be effected in the direction of magnetic field when a magnetic field is applied by the method described later can be exhibited, as aforementioned, it is preferred that the magnetic substance adhering ratio (adhered area ratio) be, for example, 30% or greater, especially 50% or greater, and still especially 80% or greater.

The thickness of the ferromagnetic substance adhered to the surface of fibrous filler is preferably in the range of, for example, 0.01 to 10 μm, still preferably 0.1 to 5 μm, and optimally 0.2 to 1 μm.

When the magnetic substance is adhered in the amount and thickness of the above ranges, the fibrous filler having the magnetic substance adhering thereto can satisfactorily be orientated in the direction of the thickness of the sheet by application of a magnetic field in the direction of the thickness of the sheet. Thus, when the fibrous filler has high electric conductivity, the resultant composite sheet can have high electric conductivity in the direction of the thickness of the sheet.

With respect to the method of adhering the magnetic substance to a fiber surface, the adhering can be accomplished by, for example, chemical plating or other electroless plating.

With respect to the configuration of magnetic fibrous filler (A) for use in the first to fifth inventions, cylindrical one is preferably employed.

The diameter of this fiber is preferably in the range of 5 to 500 μm, still preferably 10 to 200 μm.

Although the length of the fiber for use in the first to fifth inventions is not particularly limited, it is preferred that the length be such that the magnetic fibrous filler can be orientated in the composite sheet in the direction of the thickness of the sheet to thereby increase the electric conductivity in the direction of the thickness of the composite sheet. The aspect ratio of this fiber is preferably in the range of 2 to 100, still preferably 5 to 100, and optimally 10 to 50.

As aforementioned, in the fifth invention, the fiber length L₁, thickness of composite sheet D and distance between neighboring electrodes L₂ on, for example, a semiconductor element satisfy a given relationship.

(Fibrous Filler Having Thermal or Electric Conductivity and Magnetism)

When the magnetic fibrous filler (A) for use in the first to fifth inventions has high electric conductivity in the direction of fiber length, a composite sheet with anisotropic electric conductivity can be obtained. When the magnetic fibrous filler (A) has high thermal conductivity in the direction of fiber length, the obtained composite sheet can be a heat-conductive composite sheet. When the fibrous filler (A) with electric conductivity and magnetism has high thermal conductivity in the direction of fiber length, there can be obtained an anisotropic conductive composite sheet also having the function of anisotropic thermal conduction.

When it is intended to obtain a heat-conductive composite sheet, it is preferred that the thermal conductivity in a direction of fiber length (W^{●}m⁻¹ ^{●}K⁻¹) of the above magnetic fibrous filler (A) be 100 or greater, especially 500 or greater, and still especially 1200 or greater. The fibrous filler for use in the heat-conductive composite sheet is preferably any of the carbon fiber, aramide fiber, polyparabenzazole fiber and those obtained by adhering a magnetic substance to these fibers. Also, metallic fibers of Fe, Co and Ni can preferably be employed.

When it is intended to obtain a composite sheet having anisotropic electric conductivity, the fiber obtained by adhering an electrically conductive metal to the above listed metallic fiber, fiber having magnetic susceptibilities in a direction of fiber axis and in a direction of fiber circumference which are different from each other and fiber having a magnetic substance adhering thereto on its surface can be used as the magnetic fibrous filler (A). From the viewpoint of electric conductivity increase, the magnetic substance per se may have electric conductivity. When the magnetic fibrous filler originally has electric conductivity, it is not needed to adhere the electrically conductive metal. However, in the first to fifth inventions, the fibrous filler obtained by adhering the electrically conductive metal is preferred.

A noble metal which is resistant to oxidation in air and has high electric conductivity is preferably employed as the above electrically conductive metal. The noble metal can be, for example, any of gold, silver, ruthenium, palladium, rhodium, osmium, iridium and platinum. Of these, gold and silver are preferred. This noble metal may be adhered to a whole fiber surface in the form of a film, or may be adhered to part of a fiber surface, as long as the adhering is effected to such an extent that the composite sheet has electric conductivity.

With respect to the method of adhering the noble metal to a fiber surface, the adhering can be accomplished by, for example, chemical plating or other electroless plating.

The above noble metal exerts an oxidation preventive effect, so that it is preferred to adhere the noble metal to the outermost side of the fiber. As the fiber having a magnetic substance and a noble metal adhering thereto on its surface, there can be mentioned, for example, a fiber obtained by adhering nickel as a magnetic substance to a surface of carbon fiber and further adhering a noble metal such as gold or silver to a nickel surface.

It is preferred that the adhering ratio of noble metal to fibrous filler (adhered area ratio) be 30% or greater, especially 50% or greater, and still especially 80% or greater. The thickness of the noble metal adhered to the surface of fibrous filler is preferably in the range of, for example, 0.01 to 2 μm, still preferably 0.02 to 1 μm, and optimally 0.05 to 0.5 μm.

When the fiber to which the noble metal has been adhered in the amount and thickness of the above ranges is contained in the following proportion, the obtained anisotropic conductive sheet wherein the fibrous filler with magnetism and electric conductivity is orientated in the direction of the thickness of the sheet exhibits low resistance, namely high electric conductivity, in the direction of the thickness of the sheet to thereby enable attaining satisfactory electrical contact.

The magnetic fibrous filler (A) having its surface further treated with a coupling agent such as a silane coupling agent can also be appropriately employed. When the magnetic fibrous filler (A) has its surface further treated with a coupling agent, the adherence between the fibrous filler and the binder is enhanced with the result that the obtained heat-conductive composite sheet or electrically conductive composite sheet exhibits in excellent durability.

In each of the first, third, fourth and fifth inventions, the fibrous filler (A) in total is preferably contained in a proportion of 2 to 70% by volume, still preferably 10 to 60% by volume, based on the whole volume of sheeted composition.

When the proportion is less than 2% by volume, the thermal conductivity or electric conductivity in the direction of the thickness of the sheet obtained by curing of the sheeted composition may not be satisfactorily increased. On the other hand, when the proportion exceeds 70% by volume, the obtained composite sheet is-likely to be brittle, and the elasticity required for the composite sheet may not be realized.

In the second invention, the magnetic fibrous filler (A) in total is preferably contained in a proportion of 1 to 20% by volume, still preferably 2 to 15% by volume, and optimally 2 to 10% by weight, based on the whole volume of sheeted composition.

When the proportion is less than 2% by volume, the thermal conductivity or electric conductivity in the direction of the thickness of the sheet obtained by curing of the sheeted composition may not be satisfactorily increased. On the other hand, when the proportion exceeds 20 % by volume, there may be no satisfactory space for the filler to move in correspondence to magnetic field in the uncured binder with the result that the orientation is likely to become unsatisfactory.

In the second invention, the magnetic fibrous filler (A) can be distributed so as to gather at requisite portions. In this way of distribution, as compared with the distribution throughout the surface, the sheet with satisfactory anisotropic electric conductivity and thermal conductivity can be obtained even if the content of the magnetic fibrous filler (A) is small.

In the fifth invention, the magnetic fibrous filler (A) contained in the composite sheet is orientated in the direction of the thickness of the composite sheet, at least 80% (80% to 100%) of the magnetic fibrous filler (A) having a fiber length L₁ satisfying the relationship:

0.5×D<L₁<(L₂²+D²)^{1/2}

wherein D represents a thickness of composite sheet, and L₂ represents a minimum distance between neighboring electrodes on a semiconductor element or on a circuit substrate.

In the fifth invention, the fibrous filler satisfying the above relationship can be selected from among commercially available products, or can be procured by regulating fiber lengths so as to satisfy the above relationship by classification. Although known methods can be employed in the classification and the classification method is not limited, it is preferred to use a pneumatic classifier which carries out classification with the utilization of a balance of an air resistance and a centrifugal force exerted on fiber in air stream.

The fiber length L₁ of fibrous filler can be evaluated by spreading a small amount of fibers with the care for avoiding any laying of fibers one upon another, photographing the spread fibers by the use of an optical or electron microscope and carrying out an image analysis of the photograph.

### Binder (B)

Both a rubbery polymer and a resinous polymer can be used as the binder in a composition for composite sheet sheeted in the second to fifth inventions. A binder which is liquid before curing or semi-curing can preferably be employed. The binder can be loaded with a photocuring component and/or a thermosetting component. The rubbery polymer or resinous polymer as a binder constituent can also act as a photocuring component and/or a thermosetting component.

In the first invention, use is made of a binder containing a photocuring component and a thermosetting component.

The rubbery polymer, resinous polymer, photocuring component and thermosetting component for use in the second to fifth inventions, and the combination of photocuring component and thermosetting component for use in the first invention will now be described. In the second to fifth inventions as well, the photocuring component and thermosetting component can be used in combination.

(Rubbery Polymer)

As the rubbery polymer, there can be mentioned, for example, conjugated diene rubbers such as polybutadiene, natural rubber, polyisoprene, SBR, NBR and hydrogenation products thereof; block copolymers such as styrene/butadiene block copolymer, styrene/isoprene block copolymer and hydrogenation products thereof; and chloroprene rubber, urethane rubber, polyester rubber, epichlorohydrin rubber, silicone rubber, ethylene/propylene copolymer and ethylene/propylene/diene copolymer. Of these, silicone rubber is especially preferred from the viewpoint of, for example, moldability, weather resistance and heat resistance.

The silicone rubber will be described in greater detail. Liquid silicone rubber is preferably used as the silicone rubber. The liquid silicone rubber can be either of the condensation type or of the addition type. Examples of suitable silicone rubbers include dimethylsilicone raw rubber, methylphenylvinylsilicone raw rubber and derivatives thereof having a functional group such as a vinyl group, a hydroxyl group, a hydrosilyl group, a phenyl group or a fluoro group.

(Resinous Polymer)

For example, any of an epoxy resin, a phenolic resin, a melamine resin and an unsaturated polyester resin can be used as the above resinous polymer. Of them, an epoxy resin is preferably employed.

The epoxy resin preferably has at least two epoxy groups per molecule, which can be, for example, phenolic novolak epoxy resin, cresol novolak epoxy resin, bisphenol A epoxy resin, bisphenol F epoxy resin, bisphenol AD epoxy resin, an alicyclic epoxy resin, polyglycidyl (meth)acrylate or a copolymer of glycidyl (meth)acrylate and another copolymerizable monomer.

(Photocuring Component)

The photocuring component contained in the binder can be a monomer, oligomer, prepolymer or polymer capable of radical photopolymerization, cationic photopolymerization, coordination photopolymerization or photopolyaddition reaction, which can be cured by irradiation of, for example, ultraviolet light or electron beams. Among the photocuring monomer, oligomer, prepolymer and polymer, those capable of radical photopolymerization such as a (meth)acrylic compound and a vinyl ether/maleic acid copolymer and those capable of photopolyaddition reaction such as a thiol-ene compound are preferred. Of these, a (meth)acrylic compound is especially preferred. A monomer of (meth)acrylic compound whose photocuring time is short is especially preferably employed as the photocuring component in the invention.

The monomer from which the photopolymerizable monomer, oligomer, prepolymer or polymer of (meth)acrylic compound can be derived can be, for example, any of a cyano-containing vinyl compound such as acrylonitrile or methacrylonitrile, a (meth)acrylamide compound and a (meth)acrylic acid ester.

The (meth)acrylamide compound can be, for example, any of acrylamide, methacrylamide and N,N-dimethylacrylamide. These are used individually or in combination.

As the (meth)acrylic acid ester, there can be employed monofunctional (meth)acrylates such as methyl (meth)acrylate, ethyl (meth)acrylate, butyl (meth)acrylate, 2-ethylhexyl (meth)acrylate, hydroxyethyl (meth)acrylate, phenyl (meth)acrylate, benzyl (meth)acrylate, phenoxyethyl (meth)acrylate, cyclohexyl (meth)acrylate, isobornyl (meth)acrylate and tricyclodecanyl (meth)acrylate. These are used individually or in combination.

Also, there can be employed polyfunctional (meth)acrylates, including:

bifunctional (meth)acrylates, such as ethylene glycol di(meth)acrylate, diethylene glycol di(meth)acrylate, propylene glycol di(meth)acrylate, triethylene glycol di(meth)acrylate, tetraethylene glycol di(meth)acrylate, polyethylene glycol di(meth)acrylate, 1,3-butanediol di(meth)acrylate, 1,4-butanediol di(meth)acrylate, neopentyl glycol di(meth)acrylate, 1,6-hexanediol di(meth)acrylate, 1,9-nonanediol di(meth)acrylate, 1,10-decanediol di(meth)acrylate, glycerol di(meth)acrylate, diacrylate of an ethylene oxide or propylene oxide adduct of bisphenol A and bisphenol A/diepoxyacrylic acid adduct; and

trifunctional (meth)acrylates, such as trimethylolpropane tri(meth)acrylate, pentaerythritol tri(meth)acrylate and glycerol tri(meth)acrylate.

Of these, di(meth)acrylates such as diethylene glycol di(meth)acrylate, propylene glycol di(meth)acrylate, polyethylene glycol di(meth)acrylate and glycerol di(meth)acrylate are especially preferred.

These are used individually or in combination.

(Thermosetting Component)

A monomer, oligomer, prepolymer or polymer having a thermosetting functional group can be mentioned as the thermosetting component preferably employed in the binder.

The thermosetting functional group can be, for example, any of an epoxy group, a hydroxyl group, a carboxyl group, an amino group, an isocyanate group, a vinyl group and a hydrosilyl group. From the viewpoint of reactivity, an epoxy group, a vinyl group and a hydrosilyl group are preferred.

The monomer, oligomer, prepolymer or polymer having the above thermosetting functional group can be, for example, an epoxy compound, a urethane compound or a silicone compound. From the viewpoint of reduction of thermosetting time, it is preferred to employ an epoxy compound or a silicone compound. The epoxy compound or silicone compound preferably has at least two epoxy, vinyl or hydrosilyl groups in each molecule.

The molecular weight of the above epoxy compound, although not particularly limited, is generally in the range of 70 to 20,000, preferably 300 to 5000. In particular, various epoxy resins of given molecular weight or over, for example, an oligomer, prepolymer and polymer of the above epoxy compound, are preferably employed. Examples of suitable epoxy compounds include phenolic novolak epoxy resin, cresol novolak epoxy resin, bisphenol A epoxy resin, bisphenol F epoxy resin, bisphenol AD epoxy resin, an alicyclic epoxy resin, polyglycidyl (meth)acrylate or a copolymer of glycidyl (meth)acrylate and another copolymerizable monomer, as aforementioned.

When these phenolic novolak epoxy resin and other resins are used as the thermosetting component, they also can act as the resinous polymer component.

Silicon rubber containing the above vinyl group can be mentioned as the silicone compound. Vinyl-containing silicone compound can be mentioned as a preferred silicone compound from the viewpoint of reactivity with a hydrosilyl-containing compound as a curing agent. When this silicone compound is used as the thermosetting component, it can also act as the rubbery polymer component.

The silicone compound which can also act as the rubbery polymer component is commercially available, and as such there can be mentioned the room-temperature-curing two-pack addition-type thermosetting liquid silicone rubber containing a hydrosilyl compound as a curing agent.

The above resins are used individually or in combination.

(Joint use of Photocuring Component and Thermosetting Component)

The above photocuring component and thermosetting component are used in combination in the binder for use in the first invention. In the second to fifth inventions as well, these can be used in combination.

In the joint use thereof, it is preferred that the thermosetting component remain uncured under photocuring conditions. When the above photocuring component and thermosetting component are used in combination in the binder in the invention, it is preferred that the blending ratio (photocuring component/thermosetting component) be in the range of 80/20 to 20/80% by weight, especially 70/30 to 30/70% by weight, and still especially 40/60 to 60/40% by weight. When the photocuring component and thermosetting component are used in the above range, there can be obtained a composite sheet wherein the orientation of fibrous filler in the direction of the thickness of the sheet in semi-cured binder (B1) is satisfactory and which, when cured, exhibits high adherence.

With respect to the combination of photocuring component and thermosetting component, it is preferred to use the above (meth)acrylic compound in combination with the epoxy compound from the viewpoint that not only can the time of molding of semi-cured heat-conductive composite sheet be reduced but also high adherence can be exhibited.

The method of blending the photocuring component with the thermosetting component, although not particularly limited, can be, for example, as follows. When the acrylic compound monomer is used as the photocuring component and the epoxy resin as the thermosetting component, the blending can be accomplished by dissolving the epoxy resin in the acrylic compound monomer.

A compound having both a photocuring functional group and a thermosetting functional group not cured under photocuring conditions in each molecule can be used to act as not only the photocuring component but also the thermosetting component in the combined binder. The compound having a photocuring functional group can be the above (meth)acrylic compound, and the thermosetting functional group can be the above epoxy group. The compound which can act as not only the photocuring component but also the thermosetting component can be, for example, an epoxy(meth)acrylamide such as glycidyl(meth)acrylamide or an epoxy (meth)acrylate such as glycidyl (meth)acrylate or 3,4-epoxycyclohexyl (meth)acrylate.

Furthermore, a reactive monomer having an unsaturated double bond can also be contained as a binder component. The reactive monomer can be, for example, an aromatic vinyl compound, such as hydroxystyrene, isopropenylphenol, styrene, α- methylstyrene, p-methylstyrene, chlorostyrene or p-methoxystyrene, or an alicyclic vinyl compound containing a heteroatom, such as vinylpyrrolidone or vinylcaprolactam.

(Photoinitiator)

The composition to be sheeted in the first to fifth inventions can be loaded with additives according to necessity. Depending on the type of radiation employed in the curing of photocuring component, for example, in the curing by ultraviolet irradiation, the composition can be loaded with a photoinitiator or the like.

The photoinitiator is not particularly limited as long as the photocuring component contained in the sheeted composition can be cured under photocuring conditions employed in the invention. In the joint use of photocuring component and thermosetting component, the photoinitiator is not limited as long as the photocuring component can be cured while the thermosetting component remains uncured. Conventional photoinitiators can be used.

Examples of suitable photoinitiators include α-diketones such as benzil and diacetyl; acyloins such as benzoin; acyloin ethers such as benzoin methyl ether, benzoin ethyl ether and benzoin isopropyl ether; benzophenones such as thioxanthone, 2,4-diethylthioxanthone, thioxanthone-4-sulfonic acid, benzophenone, 4,4′-bis(dimethylamino)benzophenone and 4,4′-bis(diethylamino)benzophenone; acetophenones such as acetophenone, p-dimethylaminoacetophenone, α,α′-dimethoxyacetoxybenzophenone, 2,2′-dimethoxy-2-phenylacetophenone, p-methoxyacetophenone, 2-methyl[4-(methylthio)phenyl]-2-morpholino-1-propanone and 2-benzyl-2-dimethylamino-1-(4-morpholinophenyl)butan-1-one; quinones such as anthraquinone and 1,4-naphthoquinone; halogenated compounds such as phenacyl chloride, tribromomethyl phenyl sulfone and tris(trichloromethyl)-s-triazine; peroxides such as di-t-butyl peroxide; and acylphosphine oxides such as 2,4,6-trimethylbenzoyldiphenylphosphine oxide. Also, use can be made of commercially available photoinitiators such as Irgacure 184, 651, 500, 907, CG1369 and CG24-61 and Darocure 1116 and 1173 (trade names, produced by Ciba Specialty Chemicals), Lucirin LR8728 and TPO (trade names, produced by BASF), and Ubecuryl P36 (trade name, produced by UCB).

In the joint use of photocuring component and thermosetting component in the binder, photoinitiators such as Irgacure 651 and Lucirin TPO capable of realizing rapid curing are preferably used when the photocuring component contained in the sheeted composition is a (meth)acrylic compound and the thermosetting component is an epoxy compound.

The photoinitiator is preferably added in an appropriate amount taking into account, for example, a balance of actual curing velocity and working life. Practically, it is preferred that the photoinitiator be contained in the binder in an amount of 1 to 50 parts by weight, especially 5 to 30 parts by weight, per 100 parts by weight of photocuring component. When the amount of photoinitiator is less than 1 part by weight, the composition may tend to suffer a sensitivity lowering by oxygen. On the other hand, when the amount of photoinitiator exceeds 50 parts by weight, the composition may suffer deteriorations of compatibility and storage stability.

In combination with the photoinitiator, use can be made of a photoinitiation auxiliary. Using the photoinitiation auxiliary in combination with the photoinitiator is favorable as compared with the use of photoinitiator only in that the initiation reaction can be accelerated and that the curing reaction can be effectively accomplished. Conventional photoinitiation auxiliaries can be used, examples of which include aliphatic amines such as triethanolamine, methyldiethanolamine, triisopropanolamine, n-butylamine, N-methyldiethanolamine and diethylaminoethyl (meth)acrylate; and, further, Michler's ketone, 4,4′-diethylaminophenone, methyl 4-dimethylaminobenzoate, ethyl 4-dimethylaminobenzoate and isoamyl 4-dimethylaminobenzoate.

(Thermosetting Agent)

The composition to be sheeted in the first to fifth inventions may be loaded with a thermosetting agent for accelerating the curing of the thermosetting component according to necessity. Conventional thermosetting agents can be used, examples of which include amines, dicyandiamide, dibasic acid dihydrazide, imidazoles, hydrosilyl compounds and vinylsilyl compounds.

Specifically, the thermosetting agent can be, for example, any of polymethylenediamine, diethylenetriamine, dimethylaminopropylamine, bishexamethylenetriamine, diethylaminopropylamine, polyetherdiamine, 1,3-diaminocyclohexane, diaminodiphenylmethane, diaminodiphenyl sulfone, 4,4′-bis(o-toluidine), m-phenylenediamine, 2-phenyl-4-methyl-5-hydroxymethylimidazole, block imidazoles, polydimethylsiloxane having hydrosilyl groups at both molecular terminals thereof and polydimethylsiloxane having vinyl groups at both molecular terminals thereof.

The thermosetting agent is preferably added in an appropriate amount taking into account, for example, a balance of actual curing velocity and working life. Practically, it is preferred that the thermosetting agent be contained in the binder in an amount of 1 to 50 parts by weight, especially 1 to 30 parts by weight, per 100 parts by weight of thermosetting component.

Although the method of adding the above photoinitiator and thermosetting agent is not particularly limited, it is preferred that they be pre-mixed in the binder from the viewpoint of, for example, storage stability and prevention of catalyst localization at the time of component mixing.

Organic Fine Particle or Inorganic Fine Particle (C)

In the fourth invention, organic fine particles or inorganic fine particles (C) are appropriately dispersed in the binder of the composition to be sheeted. It is preferred that the organic fine particles or inorganic fine particles (C) be insulating.

Examples of suitable organic fine particles include fine particles of resins such as silicone resin, epoxy resin, phenolic resin, styrene resin and acrylic resin, and fine particles of rubbers such as silicone rubber, SBR and NBR. Of these, fine particles of silicone resin are especially preferred from the viewpoint of dispersibility in the binder.

As the inorganic fine particles, there can be used, for example, fillers such as silica, alumina and calcium carbonate. Also, there can be used inorganic fine particles of high thermal conductivity such as boron nitride, aluminum nitride and silicon nitride. Of these, boron nitride, aluminum nitride and silicon nitride are preferred.

It is preferred that the organic fine particles or inorganic fine particles (C) for use in the fourth invention have a thermal conductivity (W^{●}m⁻¹^{●}K⁻¹) of 100 or higher, especially 500 or higher, and still especially 1200 or higher.

The average diameter of the-organic fine particles or inorganic fine particles (C) for use in the fourth invention, although appropriately selected depending on the distance between neighboring carbon fibers, is preferably in the range of 1 to 100 μm, still preferably 2 to 50 μm, and optimally 2 to 20 μm.

The addition amount of organic fine particles or inorganic fine particles is preferably in the range of 2 to 50% by volume, still preferably 5 to 30% by volume, based on the volume of the composition. When the addition amount of organic fine particles or inorganic fine particles is less than 2% by volume, the effect of inhibiting the drop of insulation is likely to become unsatisfactory. On the other hand, when the addition amount exceeds 50% by volume, the orientation of fibrous filler tends to be hindered to thereby bring about electric conductivity lowering.

### Other Additive

In the first to fifth inventions, the composition to be sheeted can be loaded with common inorganic fillers such as silica powder, colloidal silica, aerogel silica and alumina according to necessity. The loading with such inorganic fillers ensures thixotropy at uncuring, increases viscosity, enhances the dispersion stability of magnetic fibrous filler (A) in the composition, and enables increasing the strength of the sheet in cured or semi-cured form.

Although the addition amount of inorganic filler is not particularly limited, using it too much may cause the orientation of magnetic fibrous filler by magnetic field to be unsatisfactory.

### Preparation of Composition to be Sheeted

The composition for sheet formation in the first to fifth inventions can be prepared by any of known methods. For example, the preparation can be accomplished by the method comprising mixing a binder and a magnetic fibrous filler optionally together with a photoinitiator, a thermosetting agent, an inorganic filler, etc. and milling the mixture.

The viscosity of the above composition for sheet formation is preferably in the range of 10,000 to 1,000,000 cp at 25° C., and the composition to be sheeted is preferably in the form of a paste.

The sheeting of the composition for sheet formation can be accomplished by conventional methods. For example, the coating method, the rolling method or the casting method can be employed.

### Process for Producing Composite Sheet

With respect to the process for producing a composite sheet according to the present invention, for example, in the first to third and fifth inventions, a composite sheet having anisotropic electric conductivity can be prepared through the steps of:

providing a composition for sheet formation comprising binder (B) and, incorporated therein, a fibrous filler (A) having a magnetic substance and a noble metal adhering thereto on its surface,

sheeting the composition, and

not only applying a magnetic field to the composition sheet in the direction of the thickness of the composition sheet so as to orientate the fibrous filler (A) having a magnetic substance and a noble metal adhering thereto on its surface in the direction of the thickness of the composition sheet but also curing or semi-curing the sheeted composition by light irradiation or heating.

In the fourth invention, a composite sheet having anisotropic electric conductivity can be prepared through the steps of:

providing a composition for sheet formation comprising binder (B) wherein organic fine particles or inorganic fine particles (C) are dispersed and, incorporated therein, a fibrous filler (A) having a magnetic substance and a noble metal adhering thereto on its surface,

sheeting the composition, and

not only applying a magnetic field to the composition sheet in the direction of the thickness of the composition sheet so as to orientate the fibrous filler (A) having a magnetic substance and a noble metal adhering thereto on its surface in the direction of the thickness of the composition sheet but also curing or semi-curing the sheeted composition by light irradiation or heating.

(Process for Producing Composite Sheet According to First to Fifth Inventions)

In the first to fifth inventions, the composite sheet having anisotropic electric conductivity can also be formed by applying, at the time of use, the composition capable of providing anisotropic electric conductivity onto a surface of matter to be covered by, for example, coating, and by thereafter not only applying a magnetic field to the applied composition in sheet form in the direction of the thickness of the composition sheet so as to orientate the fiber having a magnetic substance and a noble metal adhering thereto on its surface but also curing or semi-curing the applied composition in sheet form by light irradiation or heating.

The curing or semi-curing of sheeted composition may be performed simultaneously with the orientation of the fiber furnished with both magnetism and electric conductivity. Alternatively, the curing or semi-curing may be performed after the completion of the orientation.

In the thus obtained composite sheet, the content (by volume) of, for example, the fiber furnished on its surface with both magnetism and electric conductivity is the same as that of the aforementioned composition for sheet formation.

In the fourth invention, the content of organic fine particles or inorganic fine particles (C) is preferably in the range of 2 to 50%, still preferably 5 to 30%, based on the composite sheet. When the content of organic fine particles or inorganic fine particles is less than 2%, the effect of inhibiting the drop of insulation is likely to become unsatisfactory. On the other hand, when the content exceeds 50%, the orientation of fibrous filler tends to be hindered to thereby bring about electric conductivity lowering.

In the thus obtained composite sheet, for example, the resistance of conductive parts constituted of magnetic fibrous filler can be reduced when the magnetic fibrous filler is furnished with electric conductivity. In that instance, it is preferred that the resistance exhibited by the composite sheet with anisotropic electric conductivity in the direction of the thickness of the composite sheet be 10 ^{Ω} or less, especially 1 ^{Ω} or less, and still especially 0.1 ^{Ω} or less.

With respect to the composite sheet with anisotropic electric conductivity according to the first to fifth inventions, while the insulation in the direction perpendicular to the thickness of the sheet is high, the anisotropic electric conductivity in the direction of thickness of the sheet is high. Even if the thickness of the composite sheet with anisotropic electric conductivity is increased, the resistance of conductive parts can be held low.

The thickness of the composite sheet with anisotropic electric conductivity, although varied depending on sheet usage, height of electrodes on a circuit substrate or the like using the composite sheet, etc. and not particularly limited, can be in the range of about 50 to 1000 μm. Therefore, the composite sheet can have such a thickness that any electrode height variation can satisfactorily be absorbed.

With respect to the composite sheet with anisotropic electric conductivity as one form of composite sheet according to the present invention, the process for preparing the same will now be described in greater detail.

The strength of magnetic field applied for orientating, in the direction of the thickness of the sheet, the magnetic fibrous filler (A) with electric conductivity contained in the sheeted composition or composition applied in sheet form on the surface of a matter to be covered with respect to the composition for sheet formation for use in the first to fifth inventions is preferably in the range of about 500 to 50,000 gausses, still preferably about 2000 to 20,000 gausses. The magnetic field application time is preferably in the range of about 1 to 120 min, still preferably about 5 to 30 min. The application of magnetic field may be performed at room temperature, and the curing may be carried out while heating according to necessity.

Although the method of curing or semi-curing the sheeted composition capable of imparting anisotropic electric conductivity can be varied depending on the type of employed binder and the demanded sheet performance and is not limited, for example, the sheeted composition capable of imparting anisotropic electric conductivity wherein the above epoxy resin is used as a binder component can be cured by heating preferably at 80 to 180° C., still preferably 100 to 160° C. The method of heating is not particularly limited, and common methods can be employed. For example, the sheeted composition capable of imparting anisotropic electric conductivity can be cured with the use of common heater. The heating time, although not particularly limited, is preferably in the range of about 5 to 120 min.

Further, for example, when the above (meth)acrylic resin is used as a binder component, a sticky composite sheet with anisotropic electric conductivity can be obtained by irradiating any one selected from among visible radiation, ultraviolet radiation, infrared radiation, extreme infrared radiation, electron beams, X-rays, etc. in the presence of a photoinitiator. The method of irradiation is not particularly limited, and common methods can be employed. For example, the composite sheet with anisotropic electric conductivity may be exposed to ultraviolet radiation of specified wavelength or the like by means of common photopolymerization apparatus. In the use of ultraviolet fluorescent lamps, the irradiation time and the irradiation distance are about 2 to 3 min and about 5 to 10 cm, respectively. In the use of high-pressure mercury lamps, it is preferred that the irradiation time and the irradiation distance be about 10 to 20 sec and about 7 to 20 cm, respectively.

Even if the fibrous filler (A) is further furnished with thermal conductivity, the composite sheet with anisotropic thermal conductivity can be produced by a like process.

(Process for Producing Composite Sheet Wherein Photocuring Component and Thermosetting Component are used in Combination)

The process for producing a composite sheet from a composition wherein binder (B) containing both the photocuring component and the thermosetting component is employed is, for example, as follows. For example, with respect to a composite sheet with anisotropic electric conductivity, first, the sheeted composition capable of imparting anisotropic electric conductivity is irradiated with any one selected from among visible radiation, ultraviolet radiation, infrared radiation, extreme infrared radiation, electron beams, X-rays, etc. so as to supply energy required for curing, thereby curing the photocuring component contained in the sheeted composition. Thus, a semi-cured-composite sheet containing a semi-cured binder (B1) is obtained. Thereafter, at the time of use, the semi-cured composite sheet with anisotropic electric conductivity is interposed between employed bases, for example, between a semiconductor element or semiconductor package including electrode parts and a circuit substrate including wiring parts, and thermocompressed to thereby cure the binder. Thus, there can be obtained a composite sheet including binder (B2) wherein both the photocuring component and the thermosetting component have been cured.

In the joint use of photocuring component and thermosetting component, the method of photoirradiation for curing the photocuring component to thereby produce the semi-cured composite sheet with anisotropic electric conductivity, like the aforementioned photocuring, is not particularly limited, and common methods can be employed. For example, the composite sheet with anisotropic electric conductivity may be exposed to ultraviolet radiation of specified wavelength or the like by means of common photopolymerization apparatus. In the use of ultraviolet fluorescent lamps, the irradiation time and the irradiation distance are about 2 to 3 min and about 5 to 10 cm, respectively. In the use of high-pressure mercury lamps, it is preferred that the irradiation time and the irradiation distance be about 10 to 20 sec and about 7 to 20 cm, respectively.

The procedure for not only applying a magnetic field to the uncured sheeted composition so as to orientate the magnetic fibrous filler (A) furnished with electric conductivity in the direction of the thickness of the sheet but also performing photopolymerization to thereby obtain the semi-cured composite sheet with anisotropic electric conductivity is not particularly limited. For example, the photoirradiation may be performed simultaneously with the application of magnetic field. Alternatively, the photoirradiation for semi-curing the sheeted composition may be performed after the application of a magnetic field for orientating the magnetic fibrous filler (A) furnished with electric conductivity in the direction of the thickness of the sheet. From the viewpoint of accomplishing satisfactory orientation of the magnetic fibrous filler (A) furnished with electric conductivity, it is preferred that the photoirradiation for semi-curing the sheeted composition ensue the application of a magnetic field for orientating the magnetic fibrous filler (A) furnished with electric conductivity. Although the temperature for obtaining the semi-cured composite sheet with anisotropic electric conductivity is not particularly limited as long as the thermosetting component contained in the sheeted composition is not cured, the temperature can generally be about room temperature, preferably 20 to 100° C., and still preferably 20 to 60° C.

The anisotropic conductive composite sheet having been semi-cured by the above photocuring can be readily shaped within a short period of time.

Even if the fibrous filler (A) is further furnished with thermal conductivity, the composite sheet can be produced by a like process.

The above process for producing a composite sheet wherein the photocuring component and the thermosetting component are used in combination is essential in the first invention and optional in the second to fifth inventions.

(Process for Producing Composite Sheet Having Fibrous Filler Exposed on Surface Thereof)

In the composite sheet of the present invention produced by the foregoing process, the fibrous filler (A) may be exposed or may be present in exposable form on the surface of the composite sheet. Further, the fibrous filler (A) may be exposed on the surface of the composite sheet when the composite sheet is compressed in the direction of the thickness thereof. The expression “fibrous filler exposed on the surface of the composite sheet” used herein means that ends of the fibrous filler lie at the surface of the composite sheet in such a state that, for example, when the composite sheet has its surface coupled with a surface of another member, the fibrous filler is brought into contact with the other member.

For effectively exposing the fibrous filler (A) on the surface of the composite sheet, it is desirable to, after the formation of cured or semi-cured sheet, to remove the binder provided in the vicinity of the surface of the sheet by etching. The etching of the binder can be accomplished by the dry etching wherein, for example, O₂ plasma is employed or the wet etching wherein the binder is immersed in an alkali aqueous solution or an acid aqueous solution, depending on the type of binder. Further, with respect to the composite sheet having been cured, the method wherein the composite sheet is immersed in a solvent capable of dissolving a minute amount of uncured residue to thereby extract the uncured residue with the result that the composite sheet is shrunk is effective in facilitating the exposure of fibrous filler (A) on the surface of the composite sheet.

Although the method of compressing the composite sheet can be selected depending on, for example, the usage of the composite sheet and is not particularly limited, for example, the compression can be effected by applying, from outside, a given load in the direction of the thickness of the sheet or a given strain to the thickness of the sheet. Also, the formed sheet can be compressed with the use of curing shrinkage which occurs when the composition for sheet formation according to the present invention is converted from the uncured liquid state to the cured state. Further, the sheet can be compressed by curing the semi-cured sheet under the application of pressure by thermocompression.

(Composite Sheet with Protective Film)

The composition sheeted in the first to fifth inventions may have its surface covered with a protective film. The composite sheet with protective film wherein the magnetic fibrous filler (A) is orientated in the direction of the thickness of the sheet can be formed by subjecting the sheeted composition covered with a protective film to application of magnetic field and curing or semi-curing by exposure to radiation or heating performed in the same manner as described above.

The composite sheet with protective film will be described with reference to, for example, the first invention. Although, for example, the anisotropic conductive sheet of the first invention may have its both sides or one side covered with a protective film, it is preferred in the invention that, referring to, for example, FIG. A-2, both sides of the anisotropic conductive sheet A1 be covered with protective films A4. Referring further to, for example, FIG. A-3, the anisotropic conductive sheet A1 covered with two protective films may have at its periphery a spacer A5 provided to hold the two protective films A4 with a given space therebetween. Although the material of the spacer is not particularly limited, for example, SUS or polyethylene terephthalate can preferably be used. The dimension of spacer in the direction of the thickness of the sheet (thickness of spacer) and the length of spacer along the periphery of the sheet can be varied depending on the thickness and size of the anisotropic conductive sheet and are not particularly limited as long as the anisotropic conductive sheeted composition can be supported.

Moreover, the composite sheet with protective film will be described with reference to, for example, the fourth invention. Although the composite sheet with protective film may have its both sides or one side covered with a protective film, it is preferred in the invention that, referring to, for example, FIG. D-2, both sides of the composite sheet D1 be covered with protective films D5. Referring further to, for example, FIG. D-3, the composite sheet D1 covered with two protective films may have at its periphery a spacer D6 provided to hold the two protective films D5 with a given space therebetween. Although the material of the spacer is not particularly limited, for example, SUS or polyethylene terephthalate can preferably be used. The dimension of spacer in the direction of the thickness of the sheet (thickness of spacer) and the length of spacer along the periphery of the sheet can be varied depending on the thickness and size of the composite sheet and are not particularly limited as long as the sheeted composition can be supported.

Although the material of the protective film is not particularly limited as long as it is not detrimental to the application of magnetic field and photoirradiation and is not seriously deteriorated by the application of magnetic field, ultraviolet irradiation or other photoirradiation, etc., it is preferred that the protective film be, for example, one which is transparent, has elasticity and light resistance and has such a strength that, when stripped for subjecting the composite sheet to thermocompression bonding, etc., the stripping of the protective film can be accomplished easily without breaking. For example, polyethylene terephthalate (PET), polyimides (PI), polyethylene (PE) and the like can preferably be employed.

The thickness of the protective film, although not particularly limited, can be in the range of about 5 to 150 μm, which is preferred from the viewpoint of, for example, easiness in stripping from the composite sheet.

The method of covering the sheeted composition with the protective film is not particularly limited. For example, at the time of rolling the composition for sheet formation into a sheet, the rolling can be performed while interposing the sheeted composition between protective films under the application of magnetic field. Alternatively, for example, two protective films are held in parallel relationship with a given spacing therebetween by means of a spacer or the like, and the composition is charged between the protective films. This may be performed under the application of magnetic field.

Still alternatively, the cured or semi-cured composite sheet having both sides thereof covered with protective films can be prepared by, in the step of forming a composite sheet under the application of magnetic field, coating a film surface fitted with a spacer with the composition for sheet formation to thereby obtain a sheeted composition, subsequently adhering protective films onto the sheeted composition and thereafter effecting not only an application of magnetic field but also photoirradiation or heating.

With respect to the composite sheet with protective film as well, the use of a filler furnished with electric conductivity or thermal conductivity as the fibrous filler (A) enables providing a composite sheet with protective film having anisotropic electric conductivity or a composite sheet with protective film having thermal conductivity.

### Concrete Form of Composite Sheet Concrete Composite Sheet of First Invention

With respect to the composite sheet of the first invention produced by the above process, for example, one form of anisotropic conductive sheet can be as shown in FIG. A-1 and FIG. A-2. Referring to FIG. A-1, for example, the anisotropic conductive sheet Al of the invention comprises the binder A2 and, incorporated therein, fibers A3 having a magnetic substance and a noble metal adhering thereto and orientated in the direction of the thickness of the anisotropic conductive sheet.

FIG. A-1 is a schematic sectional view of the anisotropic conductive sheet of the invention.

Concrete Composite Sheet of Second Invention

(Magnetic Pole Plate)

In the second invention, specified magnetic pole plates are used in the above process.

In particular, these magnetic pole plates each have on its surface projected magnetic pole surface portions for localizing the magnetic field. The magnetic pole plates are preferably constituted of, for example, a ferromagnetic metal such as iron, an iron-nickel alloy, an iron-cobalt alloy, nickel or cobalt.

The magnetic fibrous filler can be bundled at desired positions of the sheet by the arranging or patterning of magnetic pole plate projections. For example, with respect to the anisotropic conductive composite sheet for use in the mounting of a semiconductor element on a substrate and in the inspection thereof, the magnetic pole plates are preferably furnished with projections such that the fibrous filler having a noble metal adhering thereto on its surface is unevenly distributed in conformity with the positions of minute electrodes of the semiconductor element. Further, with respect to the anisotropic heat-conductive composite sheet, the magnetic pole plates are still preferably furnished with projections such that the fibrous filler having high thermal conductivity in a direction of fiber length is unevenly distributed in conformity with the configuration of heating parts.

With respect to the particular arrangement or pattern of such projections, for example, the projections can be constituted of a plurality of projections arranged in the form of stripes parallel to each other or projections arranged in the form of islands with given spacings. Further, the projections may be constituted of a combination of various arrangement patterns.

The magnetic pole plates having projected magnetic pole surface portions for use in the second invention can have concave portions filled with a nonmagnetic material so that the surfaces of the magnetic pole plates are planar. Furthermore, the magnetic pole plates can have concave portions filled with a nonmagnetic material, followed by anchoring or adhering of a nonmagnetic material having projections of given configuration onto the surfaces thereof. Desired surface projections of composite sheet can be realized by selecting appropriate one from among various configurations of magnetic pole plate surfaces. For example, in the production of the anisotropic conductive composite sheet for use in the mounting of a semiconductor element on a substrate and in the inspection thereof, appropriate one can be selected from among composite sheets having projections or no projections at surfaces thereof in conformity with the configuration of electrode part bumps, height difference between resist and electrode parts, etc. With respect to the heat-conductive composite sheet as well, the surface configuration thereof can appropriately be selected in conformity with that of heating element.

The nonmagnetic material usable to fill the concave portions is not limited as long as it is a resin which is nonmagnetic and stable in heat, magnetic field, etc. For example, the nonmagnetic material can be a polyimide resin, an epoxy resin, a phenolic resin or the like.

The magnetic pole plate having at its surface projected magnetic pole surface portions for use in the second invention is preferably separable into part of a magnet such as an electromagnet and a magnetic substance plate having at its surface projected magnetic pole surface portions. In the use of the above magnetic pole plate, it is not needed to employ a magnet of specified configuration, and the magnetic pole plate having projections of desired pattern can be easily obtained by fitting a commercially available electromagnet providing parallel magnetic field with a magnetic substance plate having at its surface projected magnetic pole surface portions. For example, when the magnetic pole plate is used in the production of the anisotropic conductive composite sheet for use in the mounting of a semiconductor element on a substrate and in the inspection thereof, it is preferred that the magnetic substance plate have projections conforming to the pattern of electrode parts. The method of working such projections can appropriately be selected taking into account the arrangement of electrode parts and the electrode pitch. For example, the working of a magnetic substance plate in conformity with a semiconductor element with electrodes of minute pitch such as 100 μm or less can be accomplished by first patterning a magnetic plate material such as an iron plate according to the photolitho process using a resist and thereafter effecting plating with a magnetic substance such as Fe or Ni.

(Composite Sheet of Second Invention)

FIG. B-1(a) is a stereoscopic schematic view of the composite sheet of the second invention, as taken from the sheet surface side. FIG. B-1(b) is a schematic sectional view of the composite sheet, taken in the direction of the arrow substantially along the line a-a of FIG. B-1(a). Referring to FIG. B-1(a), in the composite sheet B1 of the invention, magnetic fibrous filler B3 is orientated in the direction of the thickness of the sheet and is bundled in the form of islands with given spacings in thermosetting and/or photocuring binder B2. FIG. B-1(b) also shows that the magnetic fibrous filler B3 is orientated in the direction of the thickness of the sheet and is bundled at given positions. The surfaces of the composite sheet are planar.

Referring to FIG. B-3(a), this composite sheet can be obtained by:

interposing sheet formation composition B7 comprising magnetic fibrous filler B5 and uncured binder B6 between a pair of magnetic pole plates B11, the magnetic pole plates B11 each comprising, referring also to FIG. B-3(b), electromagnet B10 and magnetic substance plate B8 having islanded projections B12 arranged with given spacings and-having concaves filled with nonmagnetic material B9; and

curing the composition B7 by, for example, heating while applying a parallel magnetic field to the composition B7 through the magnetic substance plates B8.

Further, for example, the use of, referring to FIG. B-3(c), magnetic substance plates B8 having striped projections B13 arranged in parallel relationship in the above process enables producing composite sheet B1 wherein, referring to FIG. B-2(b), magnetic fibrous filler B4 is orientated in the direction of the thickness of the sheet and wherein, referring to FIG. B-2(a), the magnetic fibrous filler B4 is bundled in the form of stripes arranged parallel to each other with given intervals.

When a composite sheet is produced in the same manner except that, referring to FIG. B-3(a), the concaves of the magnetic substance plate B8 are not filled with the nonmagnetic material B9, there can be obtained a composite sheet having striped or islanded projections conforming to the projections of the magnetic substance plate. Furthermore, the use of a magnetic pole plate comprising the magnetic pole plate B11 consisting of, referring to FIG. B-3(a), the magnetic substance plate B8 and the nonmagnetic material B9, the magnetic pole plate B11 having a surface onto which projections of given configuration constituted of a nonmagnetic material are further anchored or adhered, enables producing a composite sheet with any desired surface configuration.

### Concrete Composite Sheet of Third Invention

(Nonmagnetic Substance Plate Having a Plurality of Concaves on its Surface)

The nonmagnetic substance plate for use in the third invention is constituted of a nonmagnetic material which does not disturb the magnetic field and has a plurality of concaves on its surface. The nonmagnetic substance plate is preferably constituted of, for example, a composition containing a polymer such as a resist, or a nonmagnetic metal such as Cu or Al.

Projections can be provided at any desired positions of the composite sheet surface by the arranging or patterning of concaves in the nonmagnetic substance plate. For example, in the anisotropic conductive composite sheet for use in the mounting of a semiconductor element on a substrate and in the inspection thereof, it is preferred that the nonmagnetic substance plate be furnished with such concaves that the projections can be arranged in conformity with minute electrode positions of semiconductor element. With respect to the heat-conductive composite sheet, it is preferred that projections be provided at desired positions in conformity with the configuration of heating member.

With respect to the particular arrangement or pattern of such concaves in the nonmagnetic substance plate, for example, the concaves can include of a plurality of concaves arranged in the form of stripes parallel to each other or concaves arranged in the form of islands with given spacings. Further, the concaves may include a combination of various arrangement patterns.

In the use in producing the anisotropic conductive composite sheet for use in the mounting of a semiconductor element on a substrate and in the inspection thereof, it is preferred that the plurality of concaves of the nonmagnetic substance plate be provided in conformity with electrode part pattern. The method of working such concaves can appropriately be selected taking into account the arrangement of electrode parts, electrode pitch, height difference from resist, etc. With respect to the working of nonmagnetic substance plate, when the composite sheet is for a semiconductor element having electrodes of relatively large size, for example, hundreds of microns (μm), it is satisfactory to perform mechanical perforating of a Cu plate or the like. On the other hand, when the composite sheet is for a semiconductor element having electrodes of minute pitch, for example, 100 μm or less, the nonmagnetic substance plate can be obtained by first patterning a nonmagnetic plate material of Cu or the like according to the photolitho process using a resist and thereafter effecting half etching. In the formation of concaves of tens of microns (μm) which must have some depth, a plate resulting from patterning of resist provided on a Cu plate or the like as it is can be used the nonmagnetic material plate having concaves.

(Composite Sheet)

FIG. C-1(a) is a plan of the composite sheet of the third invention as viewed from the sheet surface side. FIG. C-1(b) is a sectional view of the composite sheet. Referring to FIG. C-1(a),(b), in the composite sheet Cl of the invention, magnetic fibrous filler C3 is orientated in the direction of the thickness of the sheet and has projected portions C4 in the form of islands with given spacings in thermosetting and/or photocuring binder C2.

Referring to FIG. C-3(a), this composite sheet can be obtained, for example, by:

contacting sheeted composition C6 comprising magnetic fibrous filler C3 and uncured binder C5 with nonmagnetic substance plate C8, the nonmagnetic substance plate C8 having, referring also to FIG. C-3(b), islanded concaves C7 arranged with given spacings, and further disposing spacer C9 and PET film C10 so that the composition is surrounded by the nonmagnetic substance plate C8, spacer C9 and PET film C10, and

applying a parallel magnetic field to the sheeted composition C6 with the use of permanent magnet C11, and photocuring the sheeted composition by means of ultraviolet irradiator C12. The magnetic field may be applied from one side as shown in FIG. C-3(a), or parallel magnetic field may be applied in such a manner that the sheeted composition is interposed between magnets.

Further, for example, the use of, referring to FIG. C-3(c), a nonmagnetic substance plate having striped concaves C13 arranged in parallel relationship as the nonmagnetic substance plate having a plurality of concaves C8 in the above process enables producing composite sheet Cl wherein, referring to FIG. C-2(b), the magnetic fibrous filler C3 is orientated in the binder C2 in the direction of the thickness of the sheet and wherein, referring to FIG. C-2(a), projected portions C14 are provided in the form of stripes arranged parallel to each other with given intervals.

Concrete Composite Sheet of Fourth Invention

In the fourth invention, referring to, for example, FIG. D-1, one concrete form of composite sheet having anisotropic electric conductivity D1 according to the invention comprises binder D3 in which organic fine particles or inorganic fine particles D2 are dispersed and, incorporated therein, fibrous filler D4 having a magnetic substance and a noble metal adhering thereto on its surface which is orientated in the direction of the thickness of the sheet.

FIG. D-1 is a schematic sectional view of the composite sheet having anisotropic electric conductivity according to the invention.

### Concrete Composite Sheet of Fifth Invention

FIG. E-2(a) is a plan of the anisotropic conductive sheet of the fifth invention, as viewed from the sheet surface side. FIG. E-2(b) is a sectional view of the anisotropic conductive sheet. Referring to FIG. E-2(a),(b), in the anisotropic conductive sheet E1 of the fifth invention, fibrous filler E2 having both electric conductivity and magnetism is orientated in the direction of the thickness of the sheet in thermosetting and/or photocuring binder E3.

Referring to FIG. E-3, this anisotropic conductive sheet can be obtained by photocuring a sheeted composition E4 comprising the fibrous filler E2 having both electric conductivity and magnetism and the binder E3 by means of, for example, ultraviolet irradiator E5 while applying a parallel magnetic field to the sheeted composition E4 with the use of permanent magnet E8. The sheeted composition E4 can be obtained by causing a composition for sheet formation to be interposed between PET films E6 arranged in parallel relationship with spacer E7 therebetween by rolling.

(Usage of Composite Sheet of Fifth Invention)

In the thus obtained anisotropic conductive sheet, at least 80% of the fibrous filler (A) having both electric conductivity and magnetism has fiber length L₁ specified in the present invention. Therefore, in the anisotropic conductive sheet E1 disposed between a semiconductor element E9 and a circuit substrate E10 as shown in, for example, FIG. E-4(a), the filler E2 not only exhibits excellent orientation in the direction of the thickness of the sheet but also has a fiber length suitable for the thickness of the sheet, so that, without increasing the conduction resistance in the direction of the thickness of the sheet, improvement can be achieved with respect to the problem of short circuit of neighboring electrodes Ell and that, even if the electrodes are minute, stable electric connection can be attained.

FIG. E-4(b) is a schematic sectional view of an anisotropic conductive sheet wherein mainly a filler whose fiber length does not satisfy the filler fiber length L₁ specified in the present invention and is smaller than that is contained. This anisotropic conductive sheet has poor conductivity in the direction of the thickness of the sheet and is poor in a balance of conduction resistance in the direction of the thickness of the sheet and insulation in the direction perpendicular to the thickness of the sheet, so that it may occur that the functioning as anisotropic conductive sheet is not satisfactory.

FIG. E-4(c) is a schematic sectional view of an anisotropic conductive sheet wherein mainly a filler whose fiber length does not satisfy the filler fiber length L₁ specified in the present invention and is larger than that is contained. This anisotropic conductive sheet is poor in a balance of conduction resistance in the direction of the thickness of the sheet and insulation in the direction perpendicular to the thickness of the sheet, so that it may occur that not only is the functioning as anisotropic conductive sheet unsatisfactory but also neighboring electrodes tend to be short circuited.

### Usage of Composite Sheet

The composite sheet of the present invention is excellent in anisotropic electric conductivity or anisotropic thermal conductivity. Therefore, for example, the sheet with anisotropic electric conductivity is useful as one for connecting electrode parts of, for example, a semiconductor package to a circuit substrate.

Specifically, for example, in the first invention, the contact structure A6 of the first invention, referring to FIG. A-4, comprises electrode parts A7 of a semiconductor element or semiconductor package and wiring parts A9 of a circuit substrate A8 and, interposed therebetween so as to electrically connect them to each other, the anisotropic conductive sheet Al of the present invention. This anisotropic conductive sheet Al comprises a binder and a fiber furnished at its surface with magnetism and electric conductivity, this fiber orientated in the direction of the thickness of the anisotropic conductive sheet.

The above electrical connection of electrode parts of a semiconductor element or semiconductor package to wiring parts of a circuit substrate with the anisotropic conductive sheet interposed therebetween can be accomplished interposing a semi-cured anisotropic conductive sheet between the electrode parts and the wiring parts and thereafter effecting (thermo)compression of the anisotropic conductive sheet. Specifically, not only bonding of a semiconductor element or the like and a circuit substrate to each other but also realization of a contact structure wherein electrode parts of a semiconductor element or the like and wiring parts of a circuit substrate are electrically connected to each other can be accomplished by employing, as the above anisotropic conductive sheet, a semi-cured anisotropic conductive sheet wherein a thermosetting component and a component resulting from curing of a photocuring component are contained and by curing the thermosetting component by thermocompression, etc.

Further, the composite sheet of the first invention has excellent adherence, so that peeling of electrode parts of a semiconductor element or semiconductor package and wiring parts of a circuit substrate from the anisotropic conductive sheet because of expansion or shrinkage of part material attributed to heat build-up of the semiconductor element or semiconductor package or because of vibration, impact, etc. from outside can be avoided. Still further, the anisotropic conductive sheet of the first invention is excellent in elasticity, heat resistance and mechanical strength, so that enhancement of reliability can be attained with respect to the function of semiconductor package.

With respect to the composite sheets of the second to fifth inventions as well, in the use as an anisotropic conductive sheet wherein a photocuring component and a thermosetting component are used in combination in the binder, a contact structure can be provided in the above manner.

When the cured anisotropic conductive sheets of the second to fifth inventions are used as the above anisotropic conductive sheet, temporary electrical connection can be attained, for the purpose of inspection, etc., by interposing them between a semiconductor element or the like to be inspected and an inspection substrate and applying pressure thereto.

### EFFECT OF THE INVENTION

The composite sheet of the first invention, for example, the anisotropic conductive sheet, because not only can the density of electrically conductive parts be increased but also the resistance of electrically conductive parts can be low, exhibits such an excellent anisotropic electric conductivity that the electric conductivity is high in the direction of the thickness of the sheet while the insulation is high in the direction perpendicular to the thickness of the sheet.

Further, in the semi-cured composite sheet of the first invention, an uncured thermosetting component is contained, and a magnetic fibrous filler is orientated in the direction of the thickness of the semi-cured composite sheet. Therefore, the composite sheet having been cured by thermocompression of the semi-cured composite sheet is excellent in the capability of bonding electrode parts and a circuit substrate.

Furthermore, the thickness of the anisotropic conductive sheet can be increased while maintaining low resistance, so that not only can mathematical dispersion of electrode height be absorbed but also straining of the anisotropic conductive sheet can be inhibited.

Still further, the anisotropic conductive sheet is excellent in heat resistance, durability and mechanical strength. A contact structure wherein this anisotropic conductive sheet is employed is satisfactory in the connection of electrode parts of a semiconductor element or the like to wiring parts of a circuit substrate, enables easily performing reliable electrical connection and exhibits high electric conductivity in the direction of the thickness of the sheet.

Still further, the anisotropic conductive sheet also capable of conducting heat can be obtained by employing a fibrous filler having high thermal conductivity in a direction of fiber length.

The process for producing a composite sheet according to the second invention provides a composite sheet wherein a magnetic fibrous filler is orientated in the direction of the thickness of the sheet and forms a plurality of bundles. Therefore, for example, when the fibrous filler has high electric conductivity, there can be provided an anisotropic conductive composite sheet wherein electrically conductive parts are formed at given positions, the density of electrically conductive parts can be increased, and the electrically conductive parts have low resistance and exhibit high anisotropic conductivity in the thickness direction, and which is excellent in heat resistance, durability, mechanical strength and adherence to semiconductor elements. Further, a heat-conductive composite sheet can be obtained by a similar process.

The process for producing a composite sheet according to the third invention provides a composite sheet wherein a magnetic fibrous filler is orientated in the direction of the thickness of the sheet and which has projections on at least one side thereof. Therefore, for example, when the fibrous filler has high electric conductivity, there can be obtained an anisotropic conductive composite sheet wherein the projections are formed at given positions to thereby enable effecting reliable electrical connection to minute electrode parts of a semiconductor element, and electrically conductive parts have low resistance and exhibit high anisotropic conductivity in the thickness direction, and which is excellent in heat resistance, durability and mechanical strength. Further, a heat-conductive composite sheet can be obtained by a similar process.

The composite sheet of the fourth invention, when used as the sheet with anisotropic electric conductivity, is characterized by enabling increasing the density of electrically conductive parts, causing electrically conductive parts to have low resistance and having such an excellent anisotropic electric conductivity that the electric conductivity is high in the direction of the thickness of the sheet while the insulation is high in the direction perpendicular to the thickness of the sheet. Moreover, the composite sheet is excellent in durability in that, even under such severe service conditions that an extremely large load is repeatedly imposed, the lowering of insulation in the direction perpendicular to the thickness of the sheet is inhibited.

Using a filler having high thermal conductivity in a direction of fiber length as the magnetic fibrous filler and using insulating inorganic fine particles with high thermal conductivity as the fine particles enable exhibiting excellent thermal conductivity as well as anisotropic electric conductivity. This is effective in solving the problem of malfunction attributed to heat build-up at the time of semiconductor element driving.

The composite sheet of the fifth invention, for example, the anisotropic conductive sheet is characterized by enabling reliable electrical connection with minute electrode parts of a semiconductor element, effecting improvement with respect to the problem of short circuit encountered in the direction perpendicular to the thickness of the sheet, having low resistance at electrically conductive parts, having high anisotropic electric conductivity in the thickness direction, and being excellent in heat resistance, durability and mechanical strength. Still further, the anisotropic conductive sheet also capable of conducting heat can be obtained by employing a fibrous filler having high thermal conductivity in a direction of fiber length.

### EXAMPLE

The present invention will further be illustrated below with reference to the following Examples which in no way limit the scope of the invention.

### Example A-1

[Production of Anisotropic Conductive Sheet]

Carbon fiber of 10 μm average diameter and 200 μm average length having first its surface electroless plated with nickel so that the average plating thickness was 0.8 μm and further having its surface electroless plated with gold so that the average plating thickness was 0.05 μm was provided. 60 parts of polyethylene glycol dimethacrylate (PDE400, produced by Kyoeisha Chemical Co., Ltd.) and 40 parts of bisphenol A type epoxy resin (EP1001, produced by Yuka Shell Epoxy Co., Ltd.) were mixed together, and 3% by weight, based on methacrylate, of photoinitiator (Irgacure 651, produced by Ciba-Geigy) and 10% by weight, based on epoxy resin, of imidazole curing agent (2P4MHZ-PW, produced by Shikoku Chemicals Corporation) were added to the mixture, thereby obtaining a binder. 10% by volume of the above carbon fiber was added to the binder and mixed for 30 min in vacuum. Thus, a composition for anisotropic conductive sheet was obtained.

This composition was charged between two PET films (each 50 μm thick) arranged in parallel relationship with a 0.2 mm thick spacer therebetween on an electromagnet capable of radiating magnetic force lines in the direction of the thickness of the composition, thereby obtaining a sheeted composition. At room temperature, a magnetic field of about 4000 gauss intensity was applied by the electromagnet to the sheeted composition so that magnetic force lines passed therethrough in the direction of the thickness of the sheet for 20 min. Thereafter, while continuing the application of magnetic field, the sheet was irradiated with ultraviolet light from upward for 1 min by means of an ultraviolet irradiator. Thus, a 0.2 mm thick semi-cured anisotropic conductive sheet was obtained.

The anisotropic electric conductivity of this anisotropic conductive sheet in the direction of the thickness of the sheet was evaluated in the following manner.

(1) Evaluation of Electric Conductivity in Thickness Direction

A test substrate having 1000 electrodes of 0.1 mm diameter linearly arranged at pitches of 0.2 mm was overlaid with the above anisotropic conductive sheet and further overlaid with a Ni plate having its surface plated with gold. The resultant laminate was loaded with a light weight and heated at 120° C. for 30 min to thereby adhere the anisotropic conductive sheet to the test substrate and gold-plated Ni plate. The inter-electrode resistance was measured. Thus, the electric conductivity of the anisotropic conductive sheet in the direction of the thickness of the sheet was evaluated.

(2) Evaluation of Insulation in Direction Perpendicular to Thickness

A laminate was produced in the same manner except that a resin insulation plate was used in place of the Ni plate having its surface plated with gold. The resistance between neighboring electrodes was measured. Thus, the insulation in the direction perpendicular to the thickness of the anisotropic conductive sheet was evaluated.

### Referential Example A1

[Production of Anisotropic Conductive Sheet]

Carbon fiber of 10 μm average diameter and 100 μm average length having first its surface electroless plated with nickel so that the average plating thickness was 0.8 μm and further having its surface electroless plated with silver so that the average plating thickness was 0.1 μm was provided. 15% by volume of this carbon fiber was added to a two-pack addition-type thermosetting liquid silicone rubber (containing vinylic dimethylsilicone rubber, hydrosilylated dimethylpolysilicone and platinum as a catalyst, and having a viscosity of 10 P) and mixed for 30 min in vacuum. Thus, a composition for anisotropic conductive sheet was obtained.

This composition was charged between two PET films (each 50 μm thick) arranged in parallel relationship with a 0.1 mm thick spacer therebetween on an electromagnet capable of radiating magnetic force lines in the direction of the thickness of the composition, thereby obtaining a sheeted composition. At room temperature, a magnetic field of about 4000 gauss intensity was applied by the electromagnet to the sheeted composition so that magnetic force lines passed therethrough in the direction of the thickness of the sheet for 20 min. Thereafter, while continuing the application of magnetic field, the sheet was heated at 100° C. Thus, a 0.1 mm thick cured anisotropic conductive sheet was obtained. The anisotropic electric conductivity of this anisotropic conductive sheet in the direction of the thickness of the sheet was evaluated in the following manner.

(1) Evaluation of Electric Conductivity in Thickness Direction

A test substrate having 1000 electrodes of 0.1 mm diameter linearly arranged at pitches of 0.2 mm was overlaid with the above anisotropic conductive sheet and further overlaid with a Ni plate having its surface plated with gold. The resultant laminate was loaded with a light weight, and the inter-electrode resistance was measured. Thus, the electric conductivity of the anisotropic conductive sheet in the direction of the thickness of the sheet was evaluated.

(2) Evaluation of Insulation in Direction Perpendicular to Thickness

A laminate was produced in the same manner except that a resin insulation plate was used in place of the Ni plate having its surface plated with gold. The resistance between neighboring electrodes was measured. Thus, the insulation in the direction perpendicular to the thickness of the anisotropic conductive sheet was evaluated.

### Comparative Referential Example A1

An anisotropic conductive sheet was produced in the same manner as in Referential Example A1 except that the carbon fiber surface was not plated with any magnetic substance.

The anisotropic electric conductivity thereof was evaluated in the same manner as in Referential Example A1.

### Comparative Referential Example A2

An anisotropic conductive sheet was produced in the same manner as in Referential Example A1 except that the carbon fiber surface was not plated with silver.

The anisotropic electric conductivity thereof was evaluated in the same manner as in Referential Example A1.

### Comparative Referential Example A3

A sheet was produced in the same manner as in Referential Example A1 except that the semi-cured sheet was obtained without application of a magnetic field.

The anisotropic electric conductivity thereof was evaluated in the same manner as in Referential Example A1.

The electric conductivity values of each of the sheets of Example A1, Referential Example A1 and Comparative Referential Examples A1 to A3 in the direction of the thickness of the sheet and in the direction perpendicular to the thickness of the sheet are listed in Table A-1.

With respect to the resistances in the direction of the thickness of the sheet, the resistance of less than 1 Ω was graded as A, the resistance of 1 to 10 Ω was graded as B, and the resistance of over 10 Ω was graded as C. With respect to the resistances in the direction perpendicular to the thickness of the sheet, the resistance of over 1 MΩ was graded as A, and the resistance of 1 MΩ or less was graded as C.

TABLE A-1

| | | Resistance in |
|---|---|---|
| | Resistance in | direction |
| | thickness | perpendicular to |
| | direction | thickness direction |
| Example A1 | A | A |
| Ref. Ex. A1 | A | A |
| Comp. Ref. | C | C |
| Ex. A1 | | |
| Comp. Ref. | C | C |
| Ex. A2 | | |
| Comp. Ref. | C | C |
| Ex. A3 | | |

### Example B-1

[Production of Anisotropic Conductive Composite Sheet]

(1) Preparation of Composition for Anisotropic Conductive Composite Sheet

Carbon fiber of 10 μm average diameter and 100 μm average length having first its surface electroless plated with nickel so that the average plating thickness was 0.8 μm and further having its surface electroless plated with silver so that the average plating thickness was 0.1 μm was provided. 5% by volume of this carbon fiber was added to a two-pack addition-type thermosetting liquid silicone rubber (having a viscosity of 10 P) and mixed for 30 min in vacuum. Thus, a composition for anisotropic conductive composite sheet was obtained.

(2) Processing of Magnetic Substance Plate

With the use of a 50 μm thick resist, openings of 70 μm diameter were provided on lines at pitches of 120 μm on a 5 mm thick iron plate, and patterning was carried out. The openings were plated with Ni to form magnetic poles. The surface was scrubbed, thereby obtaining a magnetic substance plate for molding an anisotropic conductive composite sheet. For enabling vertical alignment of two magnetic substance plates before use, positioning pinholes were made, on the basis of formed pattern, at four corners of each of the magnetic substance plates.

(3) Production of Anisotropic Conductive Composite Sheet

The above composition was charged between two PET films (each 50 μm thick) arranged in parallel relationship with a 0.1 mm thick spacer therebetween, thereby obtaining a sheeted composition. This sheeted composition was interposed between appropriately positioned upper and lower magnetic substance plates. At room temperature, a magnetic field of about 4000 gauss intensity was applied to the sheeted composition by an electromagnet so as to cause magnetic force lines to pass through the sheet in the direction of the thickness of the sheet for 20 min. Thereafter, while continuing the application of magnetic field, the sheet was heated at 100° C. Thus, a 0.1 mm thick cured anisotropic conductive composite sheet was obtained. The anisotropic electric conductivity of this anisotropic conductive composite sheet in the direction of the thickness of the sheet was evaluated in the following manner.

(1) Evaluation of Electric Conductivity in Thickness Direction

A test substrate having 1000 electrodes of 70 μm diameter linearly arranged at pitches of 120 μm was overlaid with the above anisotropic conductive composite sheet so that the electrode arrangement conformed to each other and further overlaid with a Ni plate having its surface plated with gold. The resultant laminate was loaded with a light weight, and the inter-electrode resistance was measured. Thus, the electric conductivity of the anisotropic conductive composite sheet in the direction of the thickness of the sheet was evaluated.

(2) Evaluation of Insulation in Direction Perpendicular to Thickness

A laminate was produced in the same manner except that a resin insulation plate was used in place of the Ni plate having its surface plated with gold. The resistance between neighboring electrodes was measured. Thus, the insulation in the direction perpendicular to the thickness of the anisotropic conductive composite sheet was evaluated.

The thermal conductivity thereof was evaluated in the following manner.

<Test of thermal conductivity>

FIG. B-4 shows a method of evaluating the thermal diffusivity of a heat-conductive composite sheet according to the thermal alternating current method. The thermal conductivity (λ) of a heat-conductive composite sheet in the direction of the thickness thereof can be determined by first measuring a phase difference of temperature change (θ) according to the thermal alternating current method, calculating the thermal diffusivity (α) therefrom on the basis of the relationship of the following formula B-2, and thereafter introducing the calculated thermal diffusivity together with the thermal capacity and density separately determined by customary methods in the following formula B-1.

Referring to FIG. B-4 , the system for measuring a phase difference of temperature change (θ) according to the thermal alternating current method includes function generator B17, lock-in amplifier B18, personal computer B19, sample B14 and electrodes B15, B16. The sample B14 at its both sides was interposed between the electrodes B15, B16 (thin film of metal provided on a glass plate by sputtering). Alternating voltage was applied to one electrode B15 to thereby heat one side of the sample B14. Temperature change was detected from a resistance change of the other electrode B16. Referring to FIG. B-5, the phase difference (θ) of temperature change (T) was measured from a delay of response. The thermal diffusivity (α) was calculated by the formula B-2, and the thermal conductivity (λ) was calculated by the formula B-1. Generally, the measuring was performed under such conditions that the compression of the sample was minimized.

Formula B-1

λ=α×cp ×ρ

λ: thermal conductivity,

α: thermal diffusivity,

Cp: thermal capacity (specific heat), and

ρ: density.

Formula B-2

θ={square root over ((πf/α)}×d+π/4

θ: phase difference of temperature change,

f: heating frequency,

d: thickness of sample, and

α: thermal diffusivity.

### Example B-2

(1) Preparation of Composition for Anisotropic Conductive Composite Sheet

Carbon fiber of 10 μm average diameter and 200 μm average length having first its surface electroless plated with nickel so that the average plating thickness was 0.8 μm and further having its surface electroless plated with gold so that the average plating thickness was 0.1 μm was provided. 10% by weight of imidazole curing agent (2P4MHZ-PW, produced by Shikoku Chemicals Corporation) was added to bisphenol A type epoxy resin (EP828, produced by Yuka Shell Epoxy Co., Ltd.), thereby obtaining a binder. 10% by volume of the above carbon fiber was added to the binder and mixed for 30 min in vacuum. Thus, a composition for anisotropic conductive composite sheet was obtained.

(2) Processing of Magnetic Substance Plate

A 5 mm thick iron plate was machined so that linear grooves of 100 μm depth and 70 μm width were arranged at pitches of 120 μm. The grooves were filled with liquid epoxy resin, and heated so that the epoxy resin was cured. Thereafter, the surface thereof was scrubbed, thereby obtaining a magnetic substance plate for molding an anisotropic conductive composite sheet. For enabling vertical alignment of two magnetic substance plates before use, positioning pinholes were made, on the basis of formed pattern, at four corners of each of the magnetic substance plates.

(3) Production of Anisotropic Conductive Composite Sheet

The above composition was charged between two PET films (each 50 μm thick) arranged in parallel relationship with a 0.2 mm thick spacer therebetween, thereby obtaining a sheeted composition. This sheeted composition was interposed between appropriately positioned upper and lower magnetic substance plates. At room temperature, a magnetic field of about 4000 gauss intensity was applied to the sheeted composition by an electromagnet so as to cause magnetic force lines to pass through the sheet in the direction of the thickness of the sheet for 20 min. Thereafter, while continuing the application of magnetic field, the sheet was heated at 100° C. Thus, a 0.2 mm thick cured anisotropic conductive composite sheet was obtained.

The anisotropic electric conductivity of the obtained anisotropic conductive composite sheet was evaluated in the same manner as in Example B-1 except that use was made of a test substrate having 1000 rectangular electrodes of 70×300 μm linearly arranged at pitches of 120 μm.

The thermal conductivity thereof was evaluated in the same manner as in Example B-1.

### Example B-3

[Production of Anisotropic Conductive Composite Sheet]

(1) Preparation of Composition for Anisotropic Conductive Composite Sheet

Carbon fiber of 10 μm average diameter and 200 μm average length having first its surface electroless plated with nickel so that the average plating thickness was 0.8 μm and further having its surface electroless plated with silver so that the average plating thickness was 0.4 μm was provided. 5% by volume of this carbon fiber was added to a two-pack addition-type thermosetting liquid silicone rubber (having a viscosity of 10 P) and mixed for 30 min in vacuum. Thus, a composition for anisotropic conductive composite sheet was obtained.

(2) Magnetic Substance Plate Having Projections on its Surface

With the use of a 50 μm thick resist, openings of 70 μm diameter were provided on lines at pitches of 120 μm on a 5 mm thick iron plate, and patterning was carried out. The openings were plated with Ni to form magnetic poles. The surface was scrubbed, thereby obtaining a smooth magnetic substance plate. Further, a 50 μm thick resist was applied onto the smooth magnetic substance plate, and openings of 70 μm diameter were provided on lines at pitches of 120 μm so as to be positioned at the above Ni magnetic poles of 100 μm. Patterning was carried out, thereby obtaining a desired magnetic substance plate. For enabling vertical alignment of two magnetic substance plates before use, positioning pinholes were made, on the basis of formed pattern, at four corners of each of the magnetic substance plates.

(3) Production of Anisotropic Conductive Composite Sheet

The above composition was charged between two PET films (each 50 μm thick) arranged in parallel relationship with a 0.2 mm thick spacer therebetween, thereby obtaining a sheeted composition. This sheeted composition was interposed between appropriately positioned upper and lower magnetic substance plates. At room temperature, a magnetic field of about 4000 gauss intensity was applied to the sheeted composition by an electromagnet so as to cause magnetic force lines to pass through the sheet in the direction of the thickness of the sheet for 20 min. Thereafter, while continuing the application of magnetic field, the sheet was heated at 100° C. Thus, a 0.1 mm thick cured anisotropic conductive composite sheet was obtained. The anisotropic electric conductivity of this anisotropic conductive composite sheet in the direction of the thickness of the sheet was evaluated in the following manner.

The anisotropic electric conductivity of the obtained anisotropic conductive composite sheet was evaluated in the same manner as in Example B-1 except that use was made of a test substrate having 1000 electrodes of 70 μm diameter linearly arranged at pitches of 120 μm, each of the electrodes having its periphery covered by a 10 μm thick resist.

The thermal conductivity thereof was evaluated in the same manner as in Example B-1.

### Comparative Example B-1

A sheet was produced in the same manner as in Example B-1 except that the cured sheet was obtained by directly interposing the sheeted composition between electromagnets and applying a magnetic field thereto, without the use of magnetic substance plates having projections on surfaces.

The anisotropic electric conductivity and thermal conductivity thereof were evaluated in the same manner as in Example B-1.

### Comparative Example B-2

An anisotropic conductive composite sheet was produced in the same manner as in Example B-1 except that the carbon fiber surface was not plated with silver.

The anisotropic electric conductivity and thermal conductivity thereof were evaluated in the same manner as in Example B-1.

### Comparative Example B-3

A sheet was produced in the same manner as in Example B-2 except that the cured sheet was obtained without application of a magnetic field.

The anisotropic electric conductivity and thermal conductivity thereof were evaluated in the same manner as in Example B-1.

(Evaluation)

The electric conductivity values of each of the sheets of Example B-1, Example B-2 and Comparative Examples B-1 to B-3 in the direction of the thickness of the sheet and in the direction perpendicular to the thickness of the sheet are listed in Table B-1. With respect to the resistances in the direction of the thickness of the sheet, the resistance of less than 1 ^{Ω} was graded as A, the resistance of 1 to 10 ^{Ω} was graded as B, and the resistance of over 10 ^{Ω} was graded as C. With respect to the resistances in the direction perpendicular to the thickness of the sheet, the resistance of over 1 M^{Ω} was graded as A, and the resistance of 1 M^{Ω} or less was graded as C.

The thermal conductivity of each of the sheets of Example B-1, Example B-2 and Comparative Examples B-1 and B-2 was compared with that of the sheet obtained in Comparative Example B-3. The former, when less than 5 times the latter, was graded as C. The former, when 5 to less than 20 times the latter, was graded as B. The former, when at least 20 times the latter, was graded as A. The results are listed in Table B-1.

TABLE B-1

| | Anisotropic electric | | |
|---|---|---|---|
| | conductivity | | |
| | | resistance in direction | |
| | resistance in | perpendicular to | |
| | thickness | thickness | Thermal |
| | direction | direction | conductivity |
| Example B-1 | A | A | A |
| Example B-2 | A | A | A |
| Example B-3 | A | A | A |
| Comp. Ex. B-1 | B | B | A |
| Comp. Ex. B-2 | B | A | A |
| Comp. Ex. B-3 | C | C | — |

### Example C-1

[Production of Anisotropic Conductive Composite Sheet]

(1) Preparation of Composition for Anisotropic Conductive Composite Sheet

Carbon fiber of 10 μm average diameter and 100 μm average length having first its surface electroless plated with nickel so that the average plating thickness was 0.8 μm and further having its surface electroless plated with silver so that the average plating thickness was 0.1 μm was provided. 20% by volume of this carbon fiber was added to a two-pack addition-type thermosetting liquid silicone rubber (having a viscosity of 10 P) and mixed for 30 min in vacuum. Thus, a composition for anisotropic conductive composite sheet was obtained.

(2) Nonmagnetic Substance Plate Having a Plurality of Concaves on its Surface

With the use of a resist, openings of 50 μm diameter were arranged in the form of a matrix at pitches of 100 μm on a 0.2 mm thick Cu plate, and patterning was carried out. The Cu was wet etched with the use of the resist as a mask, thereby obtaining a nonmagnetic substance plate having hemispherical concaves of 25 μm average depth.

(3) Production of Anisotropic Conductive Composite Sheet

The above composition was charged, while rolling, between a PET film (50 μm thick) and the above nonmagnetic substance plate arranged in parallel relationship with a 0.1 mm thick frame spacer therebetween, thereby obtaining a sheeted composition. This was performed on a permanent magnet (magnetic field intensity of about 2000 gausses) capable of radiating magnetic force lines which passed through the sheeted composition in the direction of the thickness of the sheet. The sheeted composition, while placed on the magnet, was put in an oven and heated at 100° C. Thus, a 0.1 mm thick cured anisotropic conductive composite sheet was obtained. The anisotropic electric conductivity of this anisotropic conductive composite sheet in the direction of the thickness of the sheet was evaluated in the following manner.

<Test of Anisotropic Electric Conductivity>

(1) Evaluation of Electric Conductivity in Thickness Direction

A test substrate having 100 electrodes of 100 μm diameter linearly arranged at pitches of 200 μm was overlaid with the above anisotropic conductive composite sheet and further overlaid with a Ni plate having its surface plated with gold. The resultant laminate was loaded with a light weight, and the inter-electrode resistance was measured. Thus, the electric conductivity of the anisotropic conductive composite sheet in the direction of the thickness of the sheet was evaluated.

(2) Evaluation of Insulation in Direction Perpendicular to Thickness

A laminate was produced in the same manner except that a resin insulation plate was used in place of the Ni plate having its surface plated with gold. The resistance between neighboring electrodes was measured. Thus, the insulation in the direction perpendicular to the thickness of the anisotropic conductive composite sheet was evaluated.

The thermal conductivity thereof was evaluated by the thermal alternating current method in the same manner as in Example B-1.

### Example C-2

(1) Preparation of Composition for Anisotropic Conductive Sheet

Carbon fiber of 10 μm average diameter and 200 μm average length having first its surface electroless plated with nickel so that the average plating thickness was 0.8 μm and further having its surface electroless plated with gold so that the average plating thickness was 0.1 μm was provided. 10% by weight of imidazole curing agent (2P4MHZ-PW, produced by Shikoku Chemicals Corporation) was added to bisphenol A type epoxy resin (EP828, produced by Yuka Shell Epoxy Co., Ltd.), thereby obtaining a binder. 10% by volume of the above carbon fiber was added to the binder and mixed for 30 min in vacuum. Thus, a composition for anisotropic conductive composite sheet was obtained.

(2) Nonmagnetic Substance Plate Having Concaves on its Surface

A 50 μm thick resist was applied onto a 0.2 mm thick Cu plate, and grooves of 50 μm depth and 25 μm width were linearly patterned at pitches of 50 μm. Thus, there was obtained a nonmagnetic substance plate having concaves for molding an anisotropic conductive composite sheet.

(3) Production of Anisotropic Conductive Composite Sheet

The above composition was charged, while rolling, between a PET film (50 μm thick) and the above nonmagnetic substance plate arranged in parallel relationship with a 0.2 mm thick frame spacer therebetween, thereby obtaining a sheeted composition. This was performed on a permanent magnet (magnetic field intensity of about 2000 gausses) capable of radiating magnetic force lines which passed through the sheeted composition in the direction of the thickness of the sheet. The sheeted composition, while placed on the magnet, was put in an oven and heated at 100° C. Thus, a 0.1 mm thick cured anisotropic conductive composite sheet was obtained.

The anisotropic electric conductivity of the obtained anisotropic conductive composite sheet was evaluated in the same manner as in Example C-1 except that use was made of a test substrate having 100 rectangular electrodes of 25×100 μm linearly arranged at pitches of 50 μm and that, under microscopic observation, positioning was performed so that the electrode arrangement and the projection arrangement conformed to each other.

The thermal conductivity thereof was evaluated in the same manner as in Example C-1.

### Example C-3

[Production of Anisotropic Conductive Composite Sheet]

(1) Preparation of Composition for Anisotropic Conductive Composite Sheet

Carbon fiber of 10 μm average diameter and 200 μm average length having first its surface electroless plated with nickel so that the average plating thickness was 0.8 μm and further having its surface electroless plated with gold so that the average plating thickness was 0.4 μm was provided. 5% by weight of photoinitiator (Irgacure 651, produced by Ciba-Geigy) was added to polyethylene glycol dimethacrylate (PDE400, produced by Kyoeisha Co., Ltd.), thereby obtaining a composition. 10% by volume of the above carbon fiber was added to this composition, and mixed for 30 min in vacuum. Thus, a composition for anisotropic conductive composite sheet was obtained.

(2) Nonmagnetic Substance Plate Having Concaves on its Surface

A 30 μm thick resist was applied onto a 0.2 mm thick Cu plate, and openings of 30 μm depth and 30 μm diameter were patterned in the form of a matrix at pitches of 60 μm. Thus, there was obtained a nonmagnetic substance plate having concaves for molding an anisotropic conductive composite sheet.

(3) Production of Anisotropic Conductive Composite Sheet

The above composition was charged, while rolling, between a PET film (50 μm thick) and the above nonmagnetic substance plate arranged in parallel * relationship with a 0.2 mm thick frame spacer therebetween, thereby obtaining a sheeted composition. This was performed on a permanent magnet (magnetic field intensity of about 2000 gausses) capable of radiating magnetic force lines which passed through the sheeted composition in the direction of the thickness of the sheet. The sheeted composition was irradiated with ultraviolet light from upward for 1 min by means of an ultraviolet irradiator. Thus, a 0.2 mm thick cured anisotropic conductive composite sheet was obtained.

The anisotropic electric conductivity of the obtained anisotropic conductive composite sheet was evaluated in the same manner as in Example C-1 except that use was made of a test substrate having 100 electrodes of 60 μm diameter linearly arranged at pitches of 120 μm, each of the electrodes having its periphery covered by a 20 μm thick resist.

The thermal conductivity thereof was evaluated in the same manner as in Example C-1.

### Comparative Example C-1

A sheet was produced in the same manner as in Example C-1 except that the cured sheet was obtained without application of magnetic field.

The anisotropic electric conductivity and thermal conductivity thereof were evaluated in the same manner as in Example C-1.

### Comparative Example C-2

An anisotropic conductive composite sheet was produced in the same manner as in Example C-2 except that the carbon fiber surface was not plated with gold.

The anisotropic electric conductivity and thermal conductivity thereof were evaluated in the same manner as in Example C-1.

### Comparative Example C-3

A planar sheet having no projections was produced in the same manner as in Example C-3 except that, without the use of any a nonmagnetic substance plate having concaves on its surface, the cured sheet was obtained by placing the sheeted composition at its both sides interposed between two PET films on a permanent magnet.

The anisotropic electric conductivity and thermal conductivity thereof were evaluated in the same manner as in Example C-1.

(Evaluation)

The electric conductivity values of each of the sheets of Examples C-1 to C-3 and Comparative Examples C-1 to C-3 in the direction of the thickness of the sheet and in the direction perpendicular to the thickness of the sheet are listed in Table C-1. With respect to the resistances in the direction of the thickness of the sheet, the resistance of less than 1 ^{Ω} was graded as A, the resistance of 1 to 10 ^{Ω} was graded as B, and the resistance of over 10 ^{Ω} was graded as C. With respect to the resistances in the direction perpendicular to the thickness of the sheet, the resistance of over 1 M^{Ω} was graded as A, and the resistance of 1 M^{Ω} or less was graded as C.

The thermal conductivity of each of the sheets of Examples C-1 to C-3 and Comparative Examples C-2 and C-3 was compared with that of the sheet obtained in Comparative Example C-1. The former, when less than 5 times the latter, was graded as C. The former, when 5 to less than 20 times the latter, was graded as B. The former, when at least 20 times the latter, was graded as A. The results are listed in Table C-1.

TABLE C-1

| | Anisotropic electric | | |
|---|---|---|---|
| | conductivity | | |
| | | resistance in direction | |
| | resistance in | perpendicular | |
| | thickness | to thickness | Thermal |
| | direction | direction | conductivity |
| Example C-1 | A | A | A |
| Example C-2 | A | A | A |
| Example C-3 | A | A | A |
| Comp. Ex. C-1 | C | C | — |
| Comp. Ex. C-2 | C | A | A |
| Comp. Ex. C-3 | B-C | A | A |

### Example D-1

[Production of Anisotropic Conductive Composite Sheet]

(1) Preparation of Composition for Anisotropic Conductive Composite Sheet

Carbon fiber of 10 μm average diameter and 100 μm average length having first its surface electroless plated with nickel so that the average plating thickness was 0.8 μm and further having its surface electroless plated with silver so that the average plating thickness was 0.1 μm was provided. 20% by volume of this carbon fiber together with 20% by volume of spherical silicone resin of 2 μm average particle diameter based on the two-pack addition-type thermosetting liquid silicone rubber was added to a two-pack addition-type thermosetting liquid silicone rubber (having a viscosity of 10 P) and mixed for 30 min in vacuum. Thus, a composition for anisotropic conductive composite sheet was obtained.

(2) Production of Anisotropic Conductive Composite Sheet

The above composition was charged, while rolling, between a PET film (50 μm thick) and the above nonmagnetic substance plate arranged in parallel relationship with a 0.1 mm thick frame spacer therebetween, thereby obtaining a sheeted composition. This was performed on a permanent magnet (magnetic field intensity of about 2000 gausses) capable of radiating magnetic force lines which passed through the sheeted composition in the direction of the thickness of the sheet. The sheeted composition, while placed on the magnet, was put in an oven and heated at 100° C. Thus, a 0.1 mm thick cured anisotropic conductive composite sheet was obtained. The anisotropic electric conductivity of this anisotropic conductive composite sheet in the direction of the thickness of the sheet, etc. was evaluated in the following manner.

<Test of Anisotropic Electric Conductivity>

(1) Evaluation of Electric Conductivity in Thickness Direction

A test substrate having 100 electrodes of 60 μm diameter linearly arranged at pitches of 120 μm was overlaid with the above anisotropic conductive composite sheet and further overlaid with a Ni plate having its surface plated with gold. The resultant laminate was loaded with about 200 g/mm², and the inter-electrode resistance was measured. Thus, the electric conductivity of the anisotropic conductive composite sheet in the direction of the thickness of the sheet was evaluated.

(2) Evaluation of Insulation in Direction Perpendicular to Thickness

A laminate was produced in the same manner except that a resin insulation plate was used in place of the Ni plate having its surface plated with gold. The resistance between neighboring electrodes was measured. Thus, the insulation in the direction perpendicular to the thickness of the anisotropic conductive composite sheet was evaluated.

(3) Evaluation of Durability

In the above electric conductivity evaluation and insulation evaluation, the operation of measuring under such a load that a strain of 20% of sheet thickness was applied and releasing the load was repeated 100 times. The durability was evaluated by the change of resistance value thereby.

(4) The Thermal Conductivity Thereof was Evaluated by the Thermal Alternating Current Method in the Same Manner as in Example B-1.

### Example D-2

[Production of Anisotropic Conductive Composite Sheet]

(1) Preparation of Composition for Anisotropic Conductive Composite Sheet

Carbon fiber of 10 μm average diameter and 200 μm average length having first its surface electroless plated with nickel so that the average plating thickness was 0.8 μm and further having its surface electroless plated with gold so that the average plating thickness was 0.1 μm was provided. 10% by weight of imidazole curing agent (2P4MHZ-PW, produced by Shikoku Chemicals Corporation) was added to bisphenol A type epoxy resin (EP828, produced by Yuka Shell Epoxy Co., Ltd.), thereby obtaining a binder. 15% by volume of the above carbon fiber together with 10% by volume of boron nitride powder of 5 μm average particle diameter based on the binder was added to the binder and mixed for 30 min in vacuum. Thus, a composition for anisotropic conductive composite sheet was obtained.

(2) Production of Anisotropic Conductive Composite Sheet

The above composition was charged, while rolling, between a PET film (50 μm thick) and the above nonmagnetic substance plate arranged in parallel relationship with a 0.2 mm thick frame spacer therebetween, thereby obtaining a sheeted composition. This was performed on a permanent magnet (magnetic field intensity of about 2000 gausses) capable of radiating magnetic force lines which passed through the sheeted composition in the direction of the thickness of the sheet. The sheeted composition, while placed on the magnet, was put in an oven and heated at 100° C. Thus, a 0.1 mm thick cured anisotropic conductive composite sheet was obtained.

The anisotropic electric conductivity and thermal conductivity of the obtained anisotropic conductive composite sheet were evaluated in the same manner as in Example D-1.

### Example D-3

[Production of Anisotropic Conductive Composite Sheet]

(1) Preparation of Composition for Anisotropic Conductive Composite Sheet

Carbon fiber of 10 μm average diameter and 200 μm average length having first its surface electroless plated with nickel so that the average plating thickness was 0.8 μm and further having its surface electroless plated with gold so that the average plating thickness was 0.4 μm was provided. 5% by weight of photoinitiator (Irgacure 651, produced by Ciba-Geigy) was added to polyethylene glycol dimethacrylate (PDE400, produced by Kyoeisha Co., Ltd.), thereby obtaining a composition. 10% by volume of the above carbon fiber together with 10% by volume of boron nitride powder of 10 μm average particle diameter based on the composition was added to this composition, and mixed for 30 min in vacuum. Thus, a composition for anisotropic conductive composite sheet was obtained.

(2) Production of Anisotropic Conductive Composite Sheet

The above composition was charged, while rolling, between a PET film (50 μm thick) and the above nonmagnetic substance plate arranged in parallel relationship with a 0.2 mm thick frame spacer therebetween, thereby obtaining a sheeted composition. This was performed on a permanent magnet (magnetic field intensity of about 2000 gausses) capable of radiating magnetic force lines which passed through the sheeted composition in the direction of the thickness of the sheet. The sheeted composition was irradiated with ultraviolet light from upward for 1 min by means of an ultraviolet irradiator. Thus, a 0.2 mm thick cured anisotropic conductive composite sheet was obtained.

The anisotropic electric conductivity and thermal conductivity of the obtained anisotropic conductive composite sheet were evaluated in the same manner as in Example D-1.

### Comparative Example D-1

A sheet was produced in the same manner as in Example D-1 except that the cured sheet was obtained without application of magnetic field.

The anisotropic electric conductivity and thermal conductivity thereof were evaluated in the same manner as in Example D-1.

### Comparative Example D-2

A sheet was produced in the same manner as in Example D-2 except that the carbon fiber surface was not plated with gold.

The anisotropic electric conductivity and thermal conductivity thereof were evaluated in the same manner as in Example D-1.

### Comparative Example D-3

A sheet was produced in the same manner as in Example D-3 except that boron nitride powder was not added.

The anisotropic electric conductivity and thermal conductivity thereof were evaluated in the same manner as in Example D-1.

(Evaluation)

The anisotropic electric conductivity of each of the sheets of Examples D-1 to D-3 and Comparative Examples D-1 to D-3 (electric conductivity values in the direction of the thickness of the sheet and in the direction perpendicular to the thickness of the sheet) is listed in Table D-1. With respect to the resistances in the direction of the thickness of the sheet, the resistance of less than 1 ^{Ω} was graded as A, the resistance of 1 to 10 ^{Ω} was graded as B, and the resistance of over 10 ^{Ω} was graded as C. With respect to the resistances in the direction perpendicular to the thickness of the sheet, the resistance of over 1 MΩ was graded as A, and the resistance of 1 MΩ or less was graded as C. With respect to the durability, the loading was repeated, and the measuring results of the 100th resistance were evaluated on like criteria.

The thermal conductivity of each of the sheets of Examples D-1 to D-3 and Comparative Examples D-1 and D-2 was compared with that of the sheet obtained in Comparative Example D-3. The former, when less than the latter, was graded as C. The former, when equal to or less than twice the latter, was graded as B. The former, when at least twice the latter, was graded as A. The results are listed in Table D-1.

TABLE D-1

| | Anisotropic electric conductivity | | | | |
|---|---|---|---|---|---|
| | | | Evaluation of | | |
| | | Resistance | durability | | |
| | | in | | resistance | |
| | | direction | | in direction | |
| | Resistance | perpen- | resistance | perpendicular | |
| | in | dicular to | in | to | Thermal |
| | thickness | thickness | thickness | thickness | conduc- |
| | direction | direction | direction | direction | tivity |
| Example | A | A | A | A | B |
| D-1 | | | | | |
| Example | A | A | A | A | A |
| D-2 | | | | | |
| Example | A | A | A | A | A |
| D-3 | | | | | |
| Comp. Ex. | C | C | C | C | C |
| D-1 | | | | | |
| Comp. Ex. | C | A | C | A | A |
| D-2 | | | | | |
| Comp. Ex. | A | A | A | C | — |
| D-3 | | | | | |

### Example E-1

[Production of Anisotropic Conductive Sheet]

(1) Procurement of Fibrous Filler

Carbon fiber of 10 μm diameter, at least 80% of which had a fiber length (L₁) of 60 to 130 μm, was selected from among commercially available products as a fibrous filler in order to attain the conduction between upper and lower electrodes arranged in the form of a matrix at pitches of 100 μm (L₂) by means of an anisotropic conductive sheet of 100 μm thickness (D).

The above fiber length (L₁) of at least 80% of the carbon fiber satisfied the relationship:

0.5×D<L₁<(L₂²+D²)^{1/2}.

(2) Preparation of Composition for Anisotropic Conductive Sheet

The above carbon fiber had first its surface electroless plated with nickel so that the average plating thickness was 0.8 μm and further had its surface electroless plated with silver so that the average plating thickness was 0.1 μm. 20% by volume of this carbon fiber plated with nickel and silver was added to a two-pack addition-type thermosetting liquid silicone rubber (having a viscosity of 10 P) and mixed for 30 min in vacuum. Thus, a composition for anisotropic conductive sheet was obtained.

(3) Production of Anisotropic Conductive Sheet

The above composition was charged, while rolling, between two PET films (50 μm thick) arranged in parallel relationship with a 0.1 mm thick frame spacer therebetween, thereby obtaining a sheeted composition. This was performed on a permanent magnet (magnetic field intensity of about 2000 gausses) capable of radiating magnetic force lines which passed through the sheeted composition in the direction of the thickness of the sheet. The sheeted composition, while placed on the magnet, was put in an oven and heated at 100° C. Thus, a 0.1 mm thick cured anisotropic conductive sheet was obtained. The anisotropic electric conductivity of this anisotropic conductive sheet in the direction of the thickness of the sheet, etc. was evaluated in the following manner.

<Test of Anisotropic Electric Conductivity>

(1) Evaluation of Electric Conductivity in Thickness Direction

A test substrate having 100 electrodes of 60 μm diameter linearly arranged at pitches of 100 μm was overlaid with the above anisotropic conductive sheet and further overlaid with a Ni plate having its surface plated with gold. The resultant laminate was loaded with about 200 g/mm², and the inter-electrode resistance was measured. Thus, the electric conductivity of the anisotropic conductive sheet in the direction of the thickness of the sheet was evaluated.

(2) Evaluation of Insulation in Direction Perpendicular to Thickness

A laminate was produced in the same manner except that a resin insulation plate was used in place of the Ni plate having its surface plated with gold. The resistance between neighboring electrodes was measured. Thus, the insulation in the direction perpendicular to the thickness of the anisotropic conductive sheet was evaluated.

The thermal conductivity thereof was evaluated in the same manner as in Example B-1.

### Example E-2

(1) Procurement of Fibrous Filler

Commercially available carbon fiber (10 μm diameter) after classification was provided as a fibrous filler in order to attain the conduction between upper and lower electrodes arranged in the form of a matrix at pitches of 100 μm (L₂) by means of an anisotropic conductive sheet of 200 μm thickness (D). At least 80% of the whole carbon fiber had a fiber length (L₁) of 110 to 210 μm.

The above fiber length (L₁) of at least 80% of the carbon fiber satisfied the relationship:

0.5×D<L₁<(L₂²+D²)^{1/2}.

(2) Preparation of Composition for Anisotropic Conductive Sheet

The above carbon fiber had first its surface electroless plated with nickel so that the average plating thickness was 0.8 μm and further had its surface electroless plated with gold so that the average plating thickness was 0.1 μm. Separately, 10% by weight of imidazole curing agent (2P4MHZ-PW, produced by Shikoku Chemicals Corporation) was added to bisphenol A type epoxy resin (EP828, produced by Yuka Shell Epoxy Co., Ltd.), thereby obtaining a binder. 10% by volume of the carbon fiber plated with nickel and gold based on the binder was added to the binder and mixed for 30 min in vacuum. Thus, a composition for anisotropic conductive sheet was obtained.

(3) Production of Anisotropic Conductive Sheet

The above composition was charged, while rolling, between two PET films (50 μm thick) arranged in parallel relationship with a 0.2 mm thick frame spacer therebetween, thereby obtaining a sheeted composition. This was performed on a permanent magnet (magnetic field intensity of about 2000 gausses) capable of radiating magnetic force lines which passed through the sheeted composition in the direction of the thickness of the sheet. The sheeted composition, while placed on the magnet, was put in an oven and heated at 100° C. Thus, a 0.2 mm thick cured anisotropic conductive sheet was obtained.

The anisotropic electric conductivity and thermal conductivity of the obtained anisotropic conductive sheet were evaluated in the same manner as in Example E-1.

### Example E-3

[Production of Anisotropic Conductive Sheet]

(1) Procurement of Fibrous Filler

Ni was machined into short fiber (diameter 30 μm) by the chatter vibration cutting process to provide a fibrous filler in order to attain the conduction between upper and lower electrodes arranged in the form of a matrix at pitches of 150 μm (L₂) by means of an anisotropic conductive sheet of 250 μm thickness (D). At least 80% of the whole Ni short fiber had a fiber length (L₁) of 140 to 280 μm.

The above fiber length (L₁) of at least 80% of the Ni short fiber satisfied the relationship:

0.5×D<L₁<(L₂²+D²)^{1/2}.

(2) Preparation of Composition for Anisotropic Conductive Sheet

The above Ni short fiber had its surface electroless plated with gold so that the average plating thickness was 0.4 μm. Separately, 5% by weight of photoinitiator (Irgacure 651, produced by Ciba-Geigy) was added to polyethylene glycol dimethacrylate (PDE400, produced by Kyoeisha Chemical Co., Ltd.), thereby obtaining a composition. 10% by volume of the Ni short fiber based on the composition was added to the composition and mixed for 30 min in vacuum. Thus, a composition for anisotropic conductive sheet was obtained.

(3) Production of Anisotropic Conductive Sheet

The above composition was charged, while rolling, between two PET films (50 μm thick) arranged in parallel relationship with a 0.25 mm thick frame spacer therebetween, thereby obtaining a sheeted composition. This was performed on a permanent magnet (magnetic field intensity of about 2000 gausses) capable of radiating magnetic force lines which passed through the sheeted composition in the direction of the thickness of the sheet. The sheeted composition was irradiated with ultraviolet light from upward for 1 min by means of an ultraviolet irradiator. Thus, a 0.25 mm thick cured anisotropic conductive sheet was obtained.

The anisotropic electric conductivity of the obtained anisotropic conductive sheet was evaluated in the same manner as in Example E-1 except that use was made of a test substrate having 100 electrodes of 80 μm diameter linearly arranged at pitches of 150 μm. The thermal conductivity thereof was evaluated in the same manner as in Example E-1.

### Comparative Example E-1

An anisotropic conductive sheet was produced in the same manner as in Example E-1 except that carbon fiber of 10 μm diameter, at least 40% of which had a fiber length (L₁) of 150 μm or greater, was selected from among commercially available products and used as a fibrous filler.

The anisotropic electric conductivity and thermal conductivity of the obtained anisotropic conductive sheet were evaluated in the same manner as in Example E-1.

### Comparative Example E-2

An anisotropic conductive sheet was produced in the same manner as in Example E-2 except that carbon fiber classified so that at least 50% of the whole carbon fiber had a fiber length (L₁) of 100 μm or less was used as a fibrous filler.

The anisotropic electric conductivity and thermal conductivity of the obtained anisotropic conductive sheet were evaluated in the same manner as in Example E-1.

### Comparative Example E-3

A sheet was produced in the same manner as in Example E-1 except that the cured sheet was obtained without application of magnetic field.

The anisotropic electric conductivity and thermal conductivity thereof were evaluated in the same manner as in Example E-1.

### Comparative Example E-4

An anisotropic conductive sheet was produced in the same manner as in Example E-2 except that the carbon fiber surface was not plated with gold.

The anisotropic electric conductivity and thermal conductivity thereof were evaluated in the same manner as in Example E-1.

(Evaluation)

The electric conductivity values of each of the sheets of Examples E-1 to E-3 and Comparative Examples E-1 to E-4 in the direction of the thickness of the sheet and in the direction perpendicular to the thickness of the sheet are listed in Table E-1. With respect to the resistances in the direction of the thickness of the sheet, the resistance of less than 1 Ω was graded as A, the resistance of 1 to 10 Ω was graded as B, and the resistance of over 10 Ω was graded as C. With respect to the resistances in the direction perpendicular to the thickness of the sheet, the resistance of over 1 MΩ at all 50 pairs of measuring points was graded as A, the resistance of 1 MΩ or less at up to 2 measuring points was graded as B, and the resistance of 1 MΩ or less at 10 measuring points or more was graded as C.

The thermal conductivity of each of the sheets of Examples E-1 to E-3 and Comparative Examples E-1, E-2 and E-4 was compared with that of the sheet obtained in Comparative Example E-3. The former, when less than 5 times the latter, was graded as C. The former, when 5 to less than 20 times the latter, was graded as B. The former, when at least 20 times the latter, was graded as A. The results are listed in Table E-1.

TABLE E-1

| | Anisotropic electric | | |
|---|---|---|---|
| | conductivity | | |
| | | resistance in direction | |
| | resistance in | perpendicular | |
| | thickness | to thickness | Thermal |
| | direction | direction | conductivity |
| Example E-1 | A | A | A |
| Example E-2 | A | A | A |
| Example E-3 | A | A | B |
| Comp. Ex. E-1 | A | B | A |
| Comp. Ex. E-2 | B | B | A |
| Comp. Ex. E-3 | C | C | — |
| Comp. Ex. E-4 | B | B | A |

What is claimed is:

1. A composition for composite sheet, comprising a magnetic fibrous filler (A) and a binder (B), said binder (B) comprising a photocuring component and a thermosetting component.

2. A composite sheet of given thickness in semi-cured form, comprising a semi-cured binder (B1) and, incorporated therein, a magnetic fibrous filler (A),
said semi-cured binder (B1) comprising a thermosetting component and a component resulting from curing of a photocuring component,
said magnetic fibrous filler (A) orientated in the direction of the thickness of the semi-cured composite sheet.

3. The composite sheet as claimed in claim 2, wherein the photocuring component is a (meth)acrylic compound.

4. The composite sheet as claimed in claim 2 or 3, wherein the thermosetting component is an epoxy compound.

5. The composite sheet as claimed in any of claims 2 to 4, wherein the magnetic fibrous filler (A) is a fibrous filler having both conductivity and magnetism.

6. The composite sheet as claimed in claim 5, wherein the fibrous filler having both conductivity and magnetism is constituted of a magnetic fibrous filler having a noble metal adhering thereto on its surface.

7. The composite sheet as claimed in claim 5, wherein the fibrous filler having both conductivity and magnetism is constituted of at least one member selected from the group consisting of a metallic fiber having magnetism, a fiber having magnetic susceptibilities in a direction of fiber axis and in a direction of fiber circumference which are different from each other and a fiber having a magnetic substance adhering thereto on its surface.

8. The composite sheet as claimed in claim 7, wherein the fiber having magnetic susceptibilities in a direction of fiber axis and in a direction of fiber circumference which are different from each other is a carbon fiber.

9. The composite sheet as claimed in any of claims 2 to 8, wherein the magnetic fibrous filler (A) is constituted of a fiber having a magnetic substance adhering thereto on its surface.

10. The composite sheet as claimed in any of claims 2 to 9, which is an anisotropic conductive sheet.

11. A composite sheet of given thickness in cured form, comprising a binder (B2) and, incorporated therein, a magnetic fibrous filler (A),
said binder (B2) comprising a component resulting from curing of a thermosetting component and a component resulting from curing of a photocuring component,
said magnetic fibrous filler (A) orientated in the direction of the thickness of the cured composite sheet.

12. A process for producing a composite sheet in semi-cured form, comprising the steps of:
sheeting a composition for composite sheet into a sheet of given thickness, said composition comprising a magnetic fibrous filler (A) and a binder (B), said binder (B) comprising a photocuring component and a thermosetting component, and
not only applying a magnetic field to the composition sheet in the direction of the thickness of the composition sheet so as to orientate the magnetic fibrous filler (A) in the direction of the thickness of the composition sheet but also curing the photocuring component of the sheeted composition, thereby obtaining a semi-cured composite sheet.

13. A method of using a composite sheet, said composite sheet being one of given thickness in semi-cured form comprising a semi-cured binder (B1) and, incorporated therein, a magnetic fibrous filler (A), said semi-cured binder (B1) comprising a thermosetting component and a component resulting from curing of a photocuring component, said magnetic fibrous filler (A) orientated in the direction of the thickness of the semi-cured composite sheet,
which method comprises the steps of:
interposing the semi-cured composite sheet between an electrode part of a semiconductor element or semiconductor package and a wiring part of a circuit substrate, and
curing the thermosetting component of the semi-cured composite sheet to thereby convert the semi-cured composite sheet to a cured composite sheet so that the electrode part and the wiring part are electrically connected to each other.

14. A contact structure comprising an electrode part of a semiconductor element or semiconductor package and a wiring part of a circuit substrate and, interposed therebetween so as to electrically connect them to each other, a composite sheet, said composite sheet being one of given thickness in cured form comprising a binder (B2) and, incorporated therein, a magnetic fibrous filler (A), said binder (B2) comprising a component resulting from curing of a thermosetting component and a component resulting from curing of a photocuring component, said magnetic fibrous filler (A) orientated in the direction of the thickness of the cured composite sheet.

15. A composite sheet of given thickness comprising a binder and a magnetic fibrous filler (A), said magnetic fibrous filler (A) orientated in the binder in the direction of the thickness of the composite sheet, said orientated magnetic fibrous filler (A) forming a plurality of bundles.

16. The composite sheet as claimed in claim 15, wherein the bundles of the magnetic fibrous filler (A) orientated in the direction of the thickness of the composite sheet are arranged in striped form in a direction of sheet surface.

17. The composite sheet as claimed in claim 15, wherein the bundles of the magnetic fibrous fillers (A) orientated in the direction of the thickness of the composite sheet are arranged in islanded form in a direction of sheet surface.

18. A process for producing a composite sheet, comprising the steps of:
interposing a sheeted composition of given thickness comprising a magnetic fibrous filler (A) and a thermosetting and/or photocuring binder (B) between a pair of magnetic pole plates each having on its surface projected magnetic pole surface portions, and
not only applying a magnetic field parallel to the direction of the thickness of the sheet to the sheeted composition so that the magnetic fibrous fillers (A), while being orientated in the direction of the thickness of the sheet, are bundled in the vicinity of projected magnetic pole surface portions of the magnetic pole plates but also curing the binder (B) by heating and/or light irradiation.

19. The process as claimed in claim 18, wherein the magnetic fibrous filler (A) is a conductive filler having a noble metal adhering thereto on its surface.

20. The process as claimed in claim 18, wherein the magnetic fibrous filler (A) has a thermal conductivity of 100 W^{●}m^{-1●}K⁻¹ or greater in a direction of fiber length.

21. The process as claimed in any of claims 18 to 20, wherein the magnetic fibrous filler (A) is constituted of at least one member selected from the group consisting of a metallic fiber having magnetism, a fiber having magnetic susceptibilities in a direction of fiber axis and in a direction of fiber circumference which are different from each other and a fiber having a magnetic substance adhering thereto on its surface.

22. The process as claimed in claim 21, wherein the fiber having magnetic susceptibilities in a direction of fiber axis and in a direction of fiber circumference which are different from each other is a carbon fiber.

23. The process as claimed in any of claims 18 to 22, wherein the magnetic fibrous filler (A) is constituted of a fiber having a magnetic substance adhering thereto on its surface.

24. The process as claimed in any of claims 18 to 23, wherein the projections of the magnetic pole plates each having on its surface projected magnetic pole surface portions are a plurality of projections arranged in the form of stripes parallel to each other or projections arranged in the form of islands with given spacings.

25. The process as claimed in any of claims 18 to 24, wherein the magnetic pole plates each having on its surface projected magnetic pole surface portions have concave portions filled with a nonmagnetic material so that the surfaces of the magnetic pole plates are planar.

26. The process as claimed in any of claims 18 to 25, wherein the magnetic pole plates each having on its surface projected magnetic pole surface portions have concave portions filled with a nonmagnetic material so that the surfaces of the magnetic pole plates are planar, and wherein projections of given configuration constituted of a nonmagnetic material are anchored or adhered onto the magnetic pole plate surfaces.

27. A composite sheet of given thickness comprising a binder and a magnetic fibrous filler (A), said magnetic fibrous filler (A) orientated in the binder in the direction of the thickness of the composite sheet, said composite sheet having projections on at least one side thereof.

28. The composite sheet as claimed in claim 27, wherein the projections on at least one side of the composite sheet are arranged in striped form in a direction of sheet surface.

29. The composite sheet as claimed in claim 27, wherein the projections on at least one side of the composite sheet are arranged in islanded form in a direction of sheet surface.

30. A process for producing a composite sheet, comprising the steps of:
bringing at least one side of a sheeted composition of given thickness comprising a magnetic fibrous filler (A) and a thermosetting and/or photocuring binder (B) into contact with a surface of nonmagnetic substance having a plurality of concaves, and
not only applying a magnetic field parallel to the direction of the thickness of the sheet to the sheeted composition so that the magnetic fibrous filler (A) is orientated in the direction of the thickness of the sheet but also curing the binder (B) by heating and/or light irradiation to thereby obtain a composite sheet having a plurality of projections on at least one side thereof.

31. The process as claimed in claim 30, wherein the magnetic fibrous filler (A) is a conductive filler having a noble metal adhering thereto on its surface.

32. The process as claimed in claim 30, wherein the magnetic fibrous filler (A) has a thermal conductivity of 100 W^{●}m⁻¹^{●}K⁻¹ or greater in a direction of fiber length.

33. The process as claimed in any of claims 30 to 32, wherein the magnetic fibrous filler (A) is constituted of at least one member selected from the group consisting of a metallic fiber having magnetism, a fiber having magnetic susceptibilities in a direction of fiber axis and in a direction of fiber circumference which are different from each other and a fiber having a magnetic substance adhering thereto on its surface.

34. The process as claimed in claim 33, wherein the fiber having magnetic susceptibilities in a direction of fiber axis and in a direction of fiber circumference which are different from each other is a carbon fiber.

35. The process as claimed in any of claims 30 to 34, wherein the magnetic fibrous filler (A) is constituted of a fiber having a magnetic substance adhering thereto on its surface.

36. The process as claimed in any of claims 30 to 35, wherein the concaves of the surface of nonmagnetic substance having a plurality of concaves are arranged in the form of stripes parallel to each other or arranged in the form of islands with given spacings.

37. The process as claimed in claim 31, wherein the composite sheet is an anisotropic electricity-conductive sheet.

38. The process as claimed in claim 32, wherein the composite sheet is an anisotropic heat-conductive sheet.

39. A composite sheet of given thickness comprising a magnetic fibrous filler (A), a binder cured by heating and/or light irradiation, and organic fine particles or inorganic fine particles (C), said magnetic fibrous filler (A) orientated in the direction of the thickness of the composite sheet.

40. The composite sheet as claimed in claim 39, wherein the magnetic fibrous filler (A) is constituted of at least one member selected from the group consisting of a metallic fiber having magnetism, a fiber having magnetic susceptibilities in a direction of fiber axis and in a direction of fiber circumference which are different from each other and a fiber having a magnetic substance adhering thereto on its surface.

41. The composite sheet as claimed in claim 39 or 40, wherein the magnetic fibrous filler (A) is a conductive filler having a noble metal adhering thereto on its surface and wherein the organic fine particles or inorganic fine particles (C) are insulators.

42. The composite sheet as claimed in claim 41, wherein the organic fine particles or inorganic fine particles (C) constitute insulating fine particles having an average diameter of 1 to 100 μm.

43. The composite sheet as claimed in claim 41 or 42, wherein the organic fine particles or inorganic fine particles (C) constitute insulating fine particles whose volume ratio in the composite sheet is in the range of 2 to 50%.

44. The composite sheet as claimed in any of claims 39 to 43, wherein the magnetic fibrous filler (A) has a thermal conductivity of 100 W^{●}m^{-1●}K⁻¹ or greater in a direction of fiber length and wherein the organic fine particles or inorganic fine particles (C) also have a thermal conductivity of 100 W^{●}m^{-1●}K⁻¹ or greater.

45. The composite sheet as claimed in any of claims 41 to 43, which is a sheet having anisotropic electric conductivity.

46. The composite sheet as claimed in claim 44, which is a sheet having anisotropic thermal conductivity and anisotropic electric conductivity.

47. A process for producing a composite sheet, comprising the steps of:
sheeting a composition into a sheet of given thickness, said composition comprising a magnetic fibrous filler (A), a thermosetting and/or photocuring binder (B), and organic fine particles or inorganic fine particles (C), and
not only applying a magnetic field to the composition sheet in the direction of the thickness of the composition sheet so as to orientate the magnetic fibrous filler (A) in the direction of the thickness of the composition sheet but also curing the binder (B) by heating and/or light irradiation.

48. A composite sheet of given thickness to be interposed between a semiconductor element and a circuit substrate, comprising a magnetic fibrous filler (A) orientated in the direction of the thickness of the composite sheet, at least 80% of the magnetic fibrous filler (A) having a fiber length L₁ satisfying the relationship:
0.5×D<L₁<(L₂²+D²)^{1/2} (I)
wherein L₁ represents a fiber length of magnetic fibrous filler (A), D represents a thickness of composite sheet, and L₂ represents a minimum distance between neighboring electrodes among neighboring-electrode distances with respect to electrodes arranged on a semiconductor element on its composite sheet side or neighboring-electrode distances with respect to electrodes arranged on a circuit substrate on its composite sheet side.

49. The composite sheet as claimed in claim 48, wherein the magnetic fibrous filler (A) is a fibrous filler having both conductivity and magnetism.

50. The composite sheet as claimed in claim 49, produced by a process comprising the steps of:
sheeting a composition into a sheet of given thickness, said composition comprising a fibrous filler having both conductivity and magnetism and a thermosetting and/or photocuring binder (B), and
not only applying a magnetic field to the composition sheet in the direction of the thickness of the composition sheet so as to orientate the fibrous filler having both conductivity and magnetism in the direction of the thickness of the composition sheet but also curing the binder (B) by heating and/or light irradiation.

51. The composite sheet as claimed in claim 49 or 50, wherein the fibrous filler having both conductivity and magnetism is constituted of a magnetic fibrous filler having a noble metal adhering thereto on its surface.

52. The composite sheet as claimed in any of claims 49 to 51, wherein the fibrous filler having both conductivity and magnetism is constituted of at least one member selected from the group consisting of a metallic fiber having magnetism, a fiber having magnetic susceptibilities in a direction of fiber axis and in a direction of fiber circumference which are different from each other and a fiber having a magnetic substance adhering thereto on its surface.

53. The composite sheet as claimed in claim 52, wherein the fiber having magnetic susceptibilities in a direction of fiber axis and in a direction of fiber circumference which are different from each other is a carbon fiber.

54. The composite sheet as claimed in any of claims 49 to 53, wherein the fibrous filler having both conductivity and magnetism (A1) is constituted of a fiber having a magnetic substance adhering thereto on its surface.

55. The composite sheet as claimed in any of claims 49 to 54, which is an anisotropic conductive sheet.

56. A method of using a composite sheet, comprising electrically connecting an electrode of a semiconductor element and an electrode of a circuit substrate to each other through each of the composite sheets of claims 49 to 55.
